(19) United States
(12) Patent Application Publication
(10) Pub. No.: US 2011/0206437 A1
(43) Pub. Date: Aug. 25, 2011

(54) KEYBOARD FOR A HANDHELD COMPUTER DEVICE

(76) Inventor: Paul Lloyd Baker, Glen Waverley (AU)

(21) Appl. No.: 13/034,603

(22) Filed: Feb. 24, 2011

Related U.S. Application Data
(63) Continuation-in-part of application No. 11/658,609, filed on Jan. 25, 2007.
Application No. 11/658,609 is a continuation of application No. PCT/AU2009/000974, filed on Jul. 30, 2009.

(30) Foreign Application Priority Data
Jul. 29, 2004 (AU) 2004904255
Aug. 25, 2008 (AU) 2008904358

(51) Int. Cl. B41J 5/00

(52) U.S. Cl. 400/486

(57) ABSTRACT

A one-handed keyboard for a hand held computing device is disclosed. The keyboard comprises an array of keys representing characters of an alphabet of a language. In one aspect, the array comprises keys representing frequently used vowel characters of the alphabet arranged together in series; keys representing frequently used consonant characters of the alphabet arranged adjacent to the keys representing vowel characters; and keys representing infrequently used consonant characters of the alphabet arranged in positions remote from the keys representing vowel characters. The keys may represent frequently used consonant characters are arranged in a relational order around the keys representing the vowel characters.

### CROSS-REFERENCE TO RELATED APPLICATIONS

This application is a continuation in part of U.S. patent application Ser. No. 11/658,609, filed Jan. 25, 2007, which is the national phase under 35 U.S.C. §371(c) of International Application No. PCT/AU2005/01128, filed Jul. 29, 2005, which claims priority to Australian Patent Application No. 2004904255, filed Jul. 29, 2004, each of which is hereby incorporated by reference in its entirety. This application is also a continuation of International Application No. PCT/AU2009/000974, filed Jul. 30, 2009, which claims priority to Australian Patent Application No. 2008904358 filed Aug. 25, 2008, each of which is hereby incorporated by reference in its entirety.

### BACKGROUND

1. Field of the Invention

The disclosed technology generally relates to a keyboard for a handheld computer device.

2. Background

Keyboards of various permutations and configurations have been proposed over the years to try and provide for the efficient entry of alphanumeric characters to computer devices and systems. The English QWERTY keyboard that is currently used on a number of devices evolved from the keyboard that is used for typewriters. The QWERTY layout of keys for typewriters was required to prevent the mechanical mechanism associated with the keyboard from jamming. This, of course, is no longer a problem that besets today's electronic keyboards, but the QWERTY layout is still favored by experienced touch typists. The QWERTY layout, however, continues to pose difficulties for anyone who is not an experienced touch typist. In particular, the QWERTY layout also imposes significant difficulties for users of small computer devices.

Typing textual information quickly, easily and without error into small computer devices such as mobile telephones, personal digital assistants (PDAs), and the like, is a challenge that limits the potential use of such devices. Mobile telephones include, for example, a 10 or 12 button numeric key pad, where text entry is effected by way of multi-tapping keys or by way of Tegic T9 word disambiguation software. Text entry into such devices is generally limited to SMS messages of less than 160 characters. PDAs are typically better adapted for use in entry of longer passages of text but key layouts still pose difficulties. “Smartphones” that combine the functionality of mobile telephones and PDAs are becoming increasingly more popular, but these devices suffer the same difficulties. It is possible to connect a Smartphone or a PDA with a QWERTY keyboard, however, the addition of such a device somewhat defeats the original aim of having a small portable device.

The full QWERTY keyboard has also been miniaturized to fit small handheld computer devices with either hardware buttons and thumb-boards on recent mobile messaging devices, or as a virtual software input panel. However squeezing a 10 column QWERTY keyboard across the width of a device that can comfortably sit in the hand results in a very small key board with tiny buttons that are hard to use. Further the indicia of such keyboards are typically difficult to read and use without error. These difficulties especially impact those with poor eyesight and/or large hands.

The QWERTY keyboard is designed for two-handed use where frequent two-pair letter combinations are hit by alternate hands and different fingers. As such, if one finger, or stylus, is being used to tap the keys on a QWERTY keyboard, then considerable time is spent unproductively moving the stylus from one side of the keyboard to the other. Besides slowing down text entry, this continual hand movement can be very fatiguing after typing even short passages of text.

Text entry through handwriting recognition systems is typically slower than text entry by way of a QWERTY keyboard, for example. This is largely due to the time involved in writing and recognizing a full character or word being more than the time involved in simply tapping a key.

Speech recognition systems have also been used but generally require low background noise and powerful software and hardware. Moreover, it may not always be appropriate to enter text via dictation when in the company of others. Sophisticated chording and gesture driven techniques based on shorthand techniques can typically only be applied with special interfaces and software. Furthermore, such systems generally require users to practice for a long time to acquire proficiency and acceptable productivity.

With just a single stroke or tap per character, keyboard based techniques still have potential for rapid text input. One such method involves analysis of all the letter pair frequencies in a corpus of text and use of an algorithm to create and test layouts that minimize the “travel distance” between the keys or the “travel time”. This distance-based approach has resulted in circular or square arrangements of keys of dimensions 6×5 rows with the Space keys located near the centre of the keyboard, high frequency keys closer to the centre and the lowest frequency at the far corners of the keyboard. On first appearance, these keyboards almost appear to have random, illogical letter placement. Consequently, these keyboards have proven to be difficult to learn and require a lot of practice to achieve the same level of productivity as is achievable with a QWERTY keyboard, for example.

It is generally desirable to overcome or ameliorate one or more of the above described difficulties, or at least provide a useful alternative.

### SUMMARY OF CERTAIN INVENTIVE ASPECTS

In accordance with one aspect of the present invention there is provided a one-handed keyboard for a hand held computer device comprising an array of keys representing characters of an alphabet of a language, wherein the array comprises: (a) keys representing frequently used vowel characters of the alphabet arranged together in series; (b) keys representing frequently used consonant characters of the alphabet arranged adjacent to the keys representing vowel characters; and (c) keys representing infrequently used consonant characters of the alphabet arranged in positions remote from the keys representing vowel characters, wherein the keys representing frequently used consonant characters are arranged in a relational order around the keys representing the vowel characters.

With respect to an embodiment, the keys representing frequently used consonant characters are arranged in a non-alphabetical relational order around the keys representing the vowel characters.

With respect to an embodiment, the relational order is the same as that of a QWERTY keyboard.

With respect to an embodiment, the relational order is the same as that of a DVORAK keyboard.

With respect to an embodiment, the relational order is the same as that of a German QWERTZ keyboard.

With respect to an embodiment, the relational order is the same as that of a French AZERTY keyboard.

In accordance with another aspect of the invention there is provided, a method of determining a layout of keys of a one handed keyboard of a hand held computer device, the keys representing characters of an alphabet of a language, comprising the steps of: (a) determining frequency of use of characters the alphabet; (b) arranging keys representing frequently used vowels characters of the alphabet in series on the one-handed keyboard; (c) arranging keys representing frequently used consonant characters of the alphabet adjacent to first and second sides of the vowel keys; and (d) arranging keys representing less frequently used consonant characters of the alphabet in positions on the one-handed keyboard remote from the keys representing the vowel characters, wherein the keys representing frequently used consonant keys being arranged in a relational order around the keys representing vowel characters.

With respect to an embodiment, the keys representing frequently used consonant characters are arranged in a non-alphabetical relational order around the keys representing the vowel characters.

With respect to an embodiment, the relational order is the same as that of a QWERTY keyboard.

With respect to an embodiment, the relational order is the same as that of a DVORAK keyboard.

With respect to an embodiment, the relational order is the same as that of a German QWERTZ keyboard.

With respect to an embodiment, the relational order is the same as that of a French AZERTY keyboard.

In accordance with yet another aspect of the invention, there is provided a one-handed keyboard having a layout of keys determined by the above described method.

In accordance with yet another aspect of the invention, there is provided a hand held computer device comprising the above described one-handed keyboard.

In accordance with yet another aspect of the invention, there is provided a one-handed keyboard for a hand held computer device comprising an array of keys representing characters of an alphabet of a language, wherein the array comprises: (a) keys representing frequently used vowel characters of the alphabet arranged together in series; (b) keys representing frequently used consonant characters of the alphabet arranged adjacent to the keys representing vowel characters; and (c) keys representing infrequently used consonant characters of the alphabet arranged in positions remote from the keys representing vowel characters, wherein the keys representing frequently used consonant characters are arranged in a relational order around the keys representing the vowel characters, and keys representing infrequently used consonant characters for left hand relational order consonants are arranged on the left hand side of the one-handed keyboard, and keys representing infrequently used consonant characters for right hand relational order consonants are arranged on the right hand side of the one-handed keyboard.

With respect to an embodiment, the keys representing frequently used consonant characters are arranged in accordance with a non-alphabetical relational order around the keys representing the vowel characters.

With respect to an embodiment, the relational order is the same as that of a QWERTY keyboard.

With respect to an embodiment, the relational order is the same as that of a DVORAK keyboard.

With respect to an embodiment, the relational order is the same as that of a German QWERTZ keyboard.

With respect to an embodiment, the relational order is the same as that of a French AZERTY keyboard.

In accordance with yet another aspect of the invention, there is provided a method of determining a layout of keys of a one-handed keyboard of a hand held computer device, the keys representing characters of an alphabet of a language, comprising the steps of: (a) determining frequency of use of characters the alphabet; (b) arranging keys representing frequently used vowels characters of the alphabet in series on the one-handed keyboard; (c) arranging keys representing frequently used consonant characters of the alphabet adjacent to first and second sides of the vowel keys; and arranging keys representing less frequently used consonant characters of the alphabet in positions on the keyboard remote from the keys representing the vowel characters, wherein the keys representing frequently used consonant keys being arranged in a relational order around the keys representing vowel characters, and keys representing infrequently used consonant characters for left hand relational order consonants are arranged on the left hand side of the one-handed keyboard, and keys representing infrequently used consonant characters for right hand relational order consonants are arranged on the right hand side of the one-handed keyboard.

With respect to an embodiment, the keys representing infrequently used consonant characters for left hand relational order consonants are arranged on the bottom left hand corner of the one-handed keyboard, and the keys representing infrequently used consonant characters for right hand relational order consonants are arranged on the bottom right hand corner of the one-handed keyboard

### BRIEF DESCRIPTION OF THE DRAWINGS

Preferred embodiments of the present invention are hereinafter described, by way of non-limiting example only, with reference to the accompanying drawings in which:

FIG. 1 is a schematic diagram of a key layout of a keyboard;

FIGS. 2 to 8 are schematic diagrams illustrating placement of the keys of the keyboard according to a preferred layout method;

FIGS. 9 to 10 are schematic diagrams of alternative layouts for preferred embodiments of a keyboard having a different orientation;

FIG. 11 is a chart showing the relative performance of the keyboard for different European languages;

FIG. 12 is a diagram of a preferred horizontal keyboard for the English language;

FIG. 13 is a diagram of a preferred horizontal keyboard for Gaelic;

FIG. 14 is a diagram of a preferred horizontal keyboard for South Korean transliteration;

FIG. 15 is a diagram of a preferred horizontal keyboard for Japanese Romaji;

FIG. 16 is a diagram of a preferred horizontal keyboard for the Greek language;

FIG. 17 is a diagram of a preferred horizontal keyboard for the Spanish language;

FIG. 18 is a diagram of a preferred horizontal keyboard for Arabic;

FIG. 19 is a diagram of a preferred horizontal keyboard for Russian Cyrillic;

FIGS. 20 to 29 are plan views of messaging devices, such as mobile phones, having alternative preferred keyboards according to the present invention;

FIGS. 30 to 32 are plan views of handheld game devices having alternative preferred keyboards according to the present invention;

FIGS. 33 to 35 are diagrams providing a plan view of preferred keyboard peripheral devices according to the present invention.

FIGS. 36 to 38 and 40 are diagrams of Personal Digital Assistants (PDA) having alternative screen interface keyboards according to the present invention;

FIG. 39 is a diagram of a PDA having a standard QWERTY keyboard interface;

FIG. 41 is a diagram of a PDA having a preferred touch pad keyboard according to the present invention;

FIG. 42 is a schematic diagram of an array of keys;

FIGS. 43 to 46 are schematic diagrams illustrating placement of the keys of the keyboard shown in FIG. 42 according to a preferred layout method;

FIG. 47 is a plan view of a messaging device, such as mobile phones, having a keyboard with keys arranged in accordance with the layout method shown in FIGS. 43 to 46;

FIG. 48 is a plan view of a keyboard with keys arranged in accordance with the layout method of shown in FIGS. 43 to 46;

FIG. 49 is a plan view of a keyboard with keys arranged in accordance with the layout method of shown in FIGS. 43 to 46;

FIGS. 50 to 52 are diagrams of Personal Digital Assistants (PDA) having alternative screen interface keyboards with keys arranged in accordance with the layout method shown in FIGS. 42 to 46;

FIG. 53 is a diagram of a PDA having a standard QWERTY keyboard interface;

FIG. 54 is a schematic drawing of a keyboard with keys arranged in accordance with the layout method shown in FIGS. 43 to 46; and

FIG. 55 is a schematic drawing of a keyboard with keys arranged in accordance with another layout method of a preferred embodiment of the invention.

### DETAILED DESCRIPTION OF CERTAIN INVENTIVE EMBODIMENTS

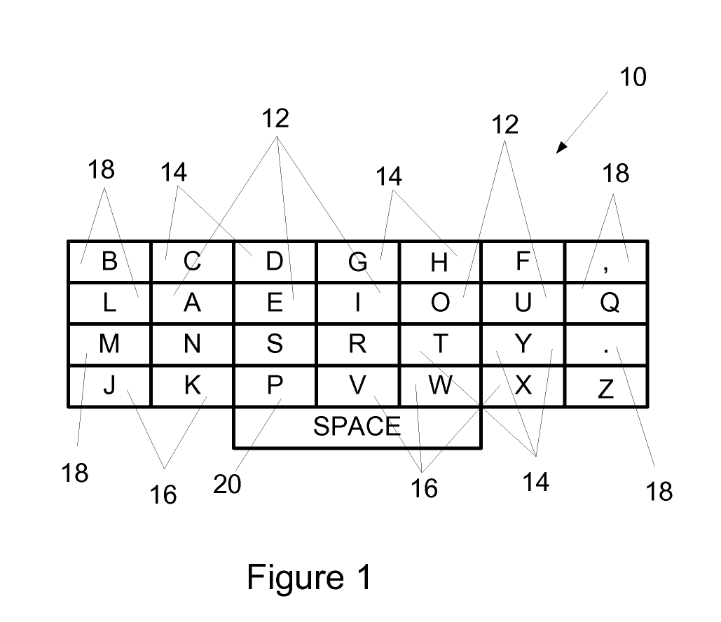

The array of character keys 10 shown in FIG. 1 represent a set of input keys of a keyboard of a handheld computer device (not shown). The array of character keys 10 includes vowel keys 12 for the vowel characters of the English language arranged side by side, in alphabetical order, across a generally central row of the array of character keys 10. The array of character keys 10 also includes commonly used consonant keys 14 (also referred to as most frequent consonant keys). The commonly used consonant keys 14 are arranged adjacent the vowel keys 12. Less commonly used consonant keys 16 (also referred to as less frequent consonant keys) are arranged adjacent the common consonant keys 14. The position of the less commonly used consonant keys 16 reduces interference with the more frequently used consonant-vowel character combinations.

The handheld computer device may be any device having data processing capabilities and which allows the input of language characters or alphanumeric characters. For example, the device may be a standard personal computer as produced by the IBM Corporation (http://www.ibm.com), a mobile telephone, such as produced by Nokia Corporation (http://www.nokia.com) or a Personal Digital Assistant (PDA), such as the iPaq produced by Hewlett-Packard (http://www.ipaq.com) or PalmOS devices produced by PalmOne, Inc. (http://www.palmone.com) or a combination smartphone device such as the P900 produced by Sony-Ericsson (http://www.sonyericsson.com).

The layout of the keys 10 of the keyboard has been determined using a layout method described below for English as a target language. The method, as will be appreciated from the description of the additional embodiments, can be readily adapted for other target languages.

The method begins with a horizontal keyboard which can then be re-oriented in final steps of the method.

Firstly data is obtained on letter use frequencies and commonly used letter pair sequences for the target language. Ideally the data is first corrected for Zipf's Law effects. Zipf's power law describes the phenomenon that just a few words are very common, while many words are very uncommon. If also available, data on the frequency of use of the first three letters of words is obtained and is used to optimise the layout for use with data input rate enhancement methods.

(ii) Determine shape of the handheld computer device to which the keyboard is coupled; the space available on the handheld computer device for the keyboard; the intended use of the handheld computer device; and the number of vowels and consonants in the target language. Visual processing research has shown that humans can simultaneously “parallel” process about 3 short rows of text imaged onto the eye to quickly identify and recognise about 20 characters. The implication is that a horizontal keyboard should, with respect to an embodiment, be as compact as possible with a target of 3 rows of common characters and as few text-free areas as possible. For example, a one-handed keyboard with 4 rows by 7 columns for the 26 letters in the English Language fits this criteria. This compact form factor also has the advantage of allowing larger buttons to be used which also increases usability. Such a layout allows the 5 vowels to be centred in the second row from the top.

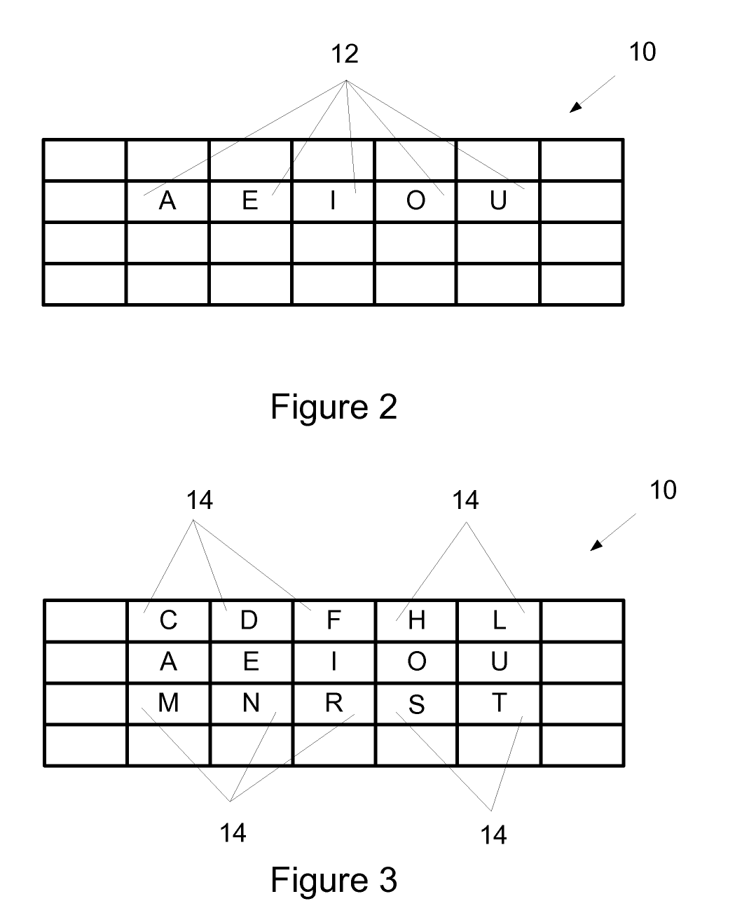

(iii) Identify the vowels in the target language in general usage and arrange them in alphabetical order on a selected generally central row of the array of keys 10 in the manner shown in FIG. 2. For English, all vowels are generally or commonly used, but other languages have accented vowels that are rarely used and should not be placed in the generally central location. Table 1 shows the vowels in the alphabet of the target language being English.

TABLE 1
Letter

A
E
I
O
U

(iv) Rank consonants of the target language in descending order of frequency of occurrence. Table 2 shows the relative frequency of use of consonants in the alphabet of the target language.

TABLE 2

| Letter | Frequency | Category |
|---|---|---|
| t | 1 | High frequency consonants up to 2 |
| | | times Number of vowels |
| n | 2 | |
| r | 3 | |
| s | 4 | |
| h | 5 | |
| d | 6 | |
| l | 7 | |
| c | 8 | |
| m | 9 | |
| w | 10 | |
| f | 11 | First 3 potential start/end members |
| g | 12 | |
| y | 13 | |
| p | 14 | Next 3 potential start/end members |
| b | 15 | |
| v | 16 | |
| k | 17 | Lower frequency consonants |
| j | 18 | |
| x | 19 | |
| q | 20 | |
| z | 21 | |

(v) Select twice the number of vowels in the target language of the most frequent consonants, i.e. 10 consonants for 5 vowels, and sort them alphabetically. Table 3 shows the high frequency consonants of the target language in alphabetical order. For the English language, 72% of words begin with a consonant and there is a 75% probability that the second letter will be a vowel. Thus, the most common consonants that start words must be easy to find and should ideally be adjacent to a vowel that is most likely to the second letter of the word. The five vowels start 28% of words (A 12%, E 2%, I 7%, O 7%, U 1%) and there is a 96% probability that the second letter is a consonant so the vowels must also be easy to find and adjacent to common consonants.

TABLE 3

| Letter | Frequency | Position |
|---|---|---|
| c | 9 | =Row above vowels |
| d | 6 | |
| f | 8 | |
| h | 5 | |
| l | 7 | |
| m | 10 | =Row below of vowels |
| n | 2 | |
| r | 3 | |
| s | 4 | |
| t | 1 | |

(vi) Arrange the first half of the high frequency consonants in alphabetical order on the top row of the array of keys 10, and the remainder of the high frequency consonants in alphabetical order below the vowels on the third row in the manner shown in FIG. 3.

(vii) Consider locations for the next six consonants from Table 2 that will potentially occupy the start/end key positions 18 of the first three rows of the array of keys 10. Determine how closely each of the six consonants corresponds to the characters surrounding each of the start/end positions 18 of the array of keys 10. Arrange a consonant in a start/end position 18 if the degree to which the consonant corresponds to the characters of the keys surrounding the start/end key position 18 is high. For example, the consonant “B” is arranged in the start position 18 of the first row of the array of keys 10 because it closely corresponds to the character “C” that is located adjacent the mentioned start position 18, as shown in FIG. 4. Determine how closely each of the remaining consonants of the six consonants corresponds to the characters in the first three rows. Replace a character in one of the first three rows if it is apparent that the replacement character would more highly correspond to the characters of the keys surrounding that position than the character that is presently in situ. For example, the consonant “G” more closely corresponds to the consonant “H” than the consonant “L”. As such, the consonant “G” replaces the consonant “L” in the second end position 18 of the first row of the array of keys 10 in the manner shown in FIG. 5. If any one of the six consonants cannot be logically arranged in the first three rows, then arrange the consonant in the last or fourth row near letters that occur in close alphabetical sequence. Adjust other positions of displaced letters accordingly. Table 4 shows the top 10 consonants and potential start/end members.

TABLE 4

| Row | Letter | Frequency | Position |
|---|---|---|---|
| Above vowels | b | 15 | =Start member |
| | c | 9 | |
| | d | 6 | |
| | f | 8 | |
| | h | 5 | |
| | g | 11 | =Displace L |
| | l | 7 | =End member of top or start |
| | | | member of next row |
| Vowels | A | | |
| | E | | |
| | I | | |
| | O | | |
| | U | | |
| Below vowels | m | 10 | |
| | n | 2 | |
| | r | 3 | |
| | s | 4 | |
| | t | 1 | |
| | y | 12 | |
| Last or 4^{th} Row | p | 13 | Remaining 3 potential start/end |
| | | | members placed in last row since |
| | | | less frequent |
| | w | 14 | |
| | v | 16 | |

(viii) Select a preliminary position for the “Space” key 20 preferably near the centre of the bottom of the grid, as shown in FIG. 6. This position was found to be preferable in eye-gaze tracking tests of novice users.

(xi) Arrange the remaining low frequency consonants from Table 2 on the array of keys 10 in alphabetical order, or within proximity to close alphabetical groups, in the manner shown in FIG. 7. Make minor adjustments such as swapping letters into alphabetical sequence. Table 5 shows all letters including low frequency consonants. If fewer keys are desired on the keyboard then the lowest frequency characters can be added to other more frequent keys in conjunction with a suitable disambiguation mechanism such as double-tapping and/or basic word disambiguation software logic.

TABLE 5

| Row | Letter | Frequency | Position |
|---|---|---|---|
| Above vowels | b | 15 | Start member |
| | c | 9 | |
| | d | 6 | |
| | f | 8 | |
| | h | 5 | |
| | g | 11 | |
| | j | 19 | End member |
| Vowels | l | 7 | Set L as start of vowel row |
| | A | | |
| | E | | |
| | I | | |
| | O | | |
| | U | | |
| | q | 20 | Set end member. Occurs often |
| | | | with “U” |
| Below vowels | m | 10 | Set as start member |
| | n | 2 | |
| | r | 3 | |
| | s | 4 | |
| | t | 1 | |
| | y | 12 | |
| Last or 4^{th} Row | j | 19 | Low frequency consonant. Grouped |
| | | | below “l”, “m” and “n”. |
| | k | 17 | |
| | p | 13 | Remaining 3 potential start/end |
| | | | members placed in last row since |
| | | | less frequent |
| | w | 14 | |
| | v | 16 | |
| | x | 18 | Place after “w” and “v”. |
| | z | 21 | Place in alphabetical order after “y” |

(x) Validate and test the keyboard 10 with the top 10-100+ words in the target language. Set out below are examples of most common words in English, German, French and Dutch.

| English | German | French | Dutch |
|---|---|---|---|
| the | der | de | de |
| of | die | la | van |
| to | und | le | een |
| and | in | et | het |
| a | den | les | en |
| in | von | des | in |
| for | zu | en | is |
| is | das | un | dat |
| The | mit | du | op |
| that | sich | une | te |
| on | des | que | De |
| said | auf | est | zijn |
| with | fur | pour | voor |
| be | ist | qui | met |
| was | im | dans | die |
| by | dem | a | niet |
| as | nicht | par | aan |
| are | ein | plus | er |
| at | Die | pas | om |
| from | eine | au | Het |
| it | als | sur | ook |
| has | auch | ne | als |
| an | es | se | dan |
| have | an | Le | maar |
| will | werden | ce | bij |
| or | aus | il | of |
| its | er | sont | uit |
| he | hat | La | nog |
| not | daβ | Les | worden |
| were | sie | ou | door |

In English, the most common words are “the” and “and”, while words containing “th” are relatively uncommon in other languages not influenced by ancient Norse.

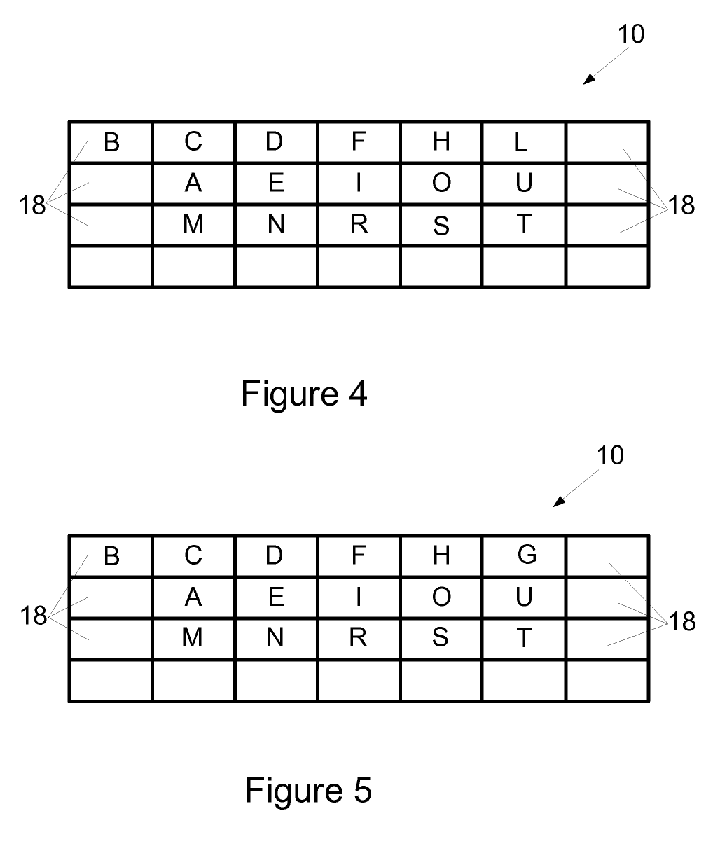

The test is extended so as to be conducted when data input rate enhancement methods are added and used with the keyboard. These methods are normally implemented in software and provide predictive word and phrase completion, using “flexible spelling” which predicts words that are spelt phonetically, word bank lists, grammar, “learning” dictionaries, suggested endings, and abbreviation expansion. The keyboard is fine-tuned for common letter-pair combinations such as prefixes that start words where appropriate, which can give the layout shown in FIG. 8. For example, “AS” is a common combination and the “S” character could be swapped with “R” character so that “S” is closer to “A”. In making this change, the third row of the array 10 includes the familiar “RTY” sequence found on QWERTY keyboards. Table 6 shows a refinement of final letter positions. If a different orientation of the array of keys 10 is required, then simple rotations and reversals can be made during the layout method to achieve a suitable result. Examples of such different layouts of the keys 10 derived using the layout method for different orientations are shown in FIGS. 9 and 10.

TABLE 6

| Row | Letter | Frequency | Reasons for change of position. |
|---|---|---|---|
| Above vowels | b | 15 | |
| | c | 9 | |
| | d | 6 | |
| | g | 11 | Swap “g” with “f” to make “ing” |
| | | | easier to type |
| | h | 5 | |
| | f | 8 | |
| | , | | Use last open key for the comma |
| | | | symbol. |
| Vowels | l | 7 | |
| | A | | |
| | E | | |
| | I | | |
| | O | | |
| | U | | |
| | q | 20 | |
| Below vowels | m | 10 | |
| | n | 2 | |
| | s | 4 | Swap “s” with “r” since “as” is |
| | | | common & also now forms |
| | | | familiar “rty”sequence found |
| | | | on QWERTY keyboards. |
| | r | 3 | |
| | t | 1 | |
| | y | 12 | |
| | . | | Use last open key for full stop |
| | | | symbol. |
| Last or 4^{th} Row | j | 19 | |
| | k | 17 | |
| | p | 13 | |
| | v | 16 | Swap “v” with “w” to create |
| | | | alphabetical “v, w, x” sequence. |
| | w | 14 | |
| | x | 18 | |
| | z | 21 | |

(xi) Arrange control, number and function buttons on the array of keys 10 to suit the shape of the hand held computer device. Control characters can be placed to suit the purpose and physical construction and ergonomic constraints of a specific handheld computer device. For example, a telephone or calculator device may have numeric indicia placed on dual-purpose keys to enable easy dialing. For some dual thumb or two-handed embodiments described later, splitting the keyboard into a left and right half is also performed here while trying to achieve a balanced workload between left and right hands.

(xii) Test the arranged characters with novice users for “intuitive” ease of learning and speed of typing compared to their past performance or competing designs. Tests are completed with and without the computer device having rate enhancement methods enabled, and the layout can be adjusted based on user feedback.

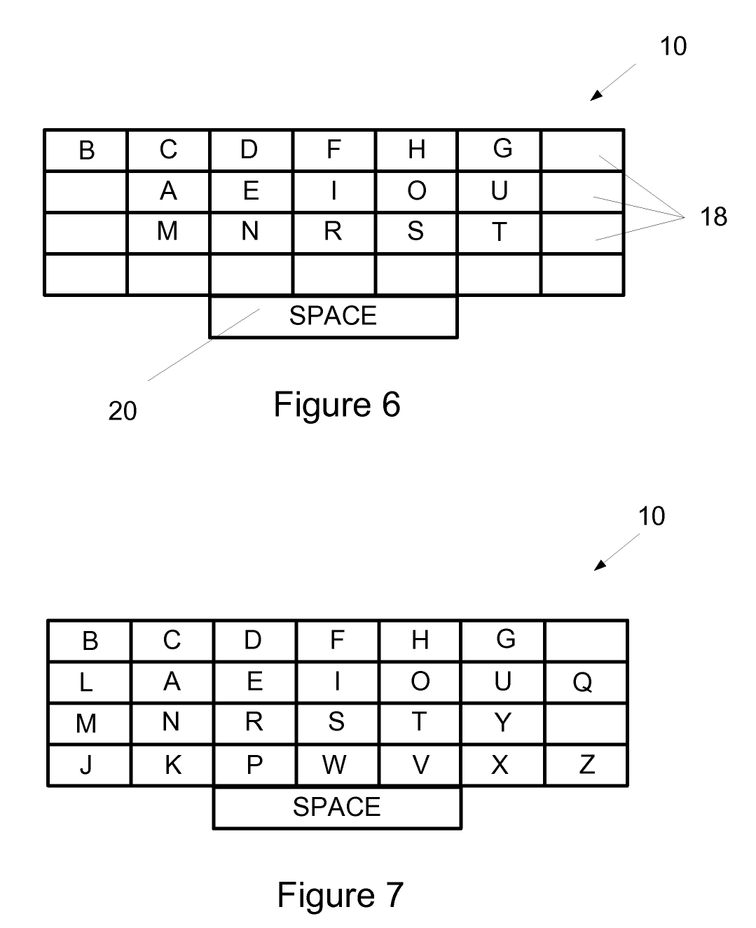

Using Soukereff and Mackenzie's industry recognised modelling technique, the theoretical performance of the following keyboards for a number of European languages is shown in FIG. 11:

1. The QWERTY keyboard;

2. A 4×7 alphabetical keyboard; and

3. A keyboard having the array of keys 10 shown in FIG. 1.

The keyboard having the array of keys 10 shown in FIG. 1 is consistently 30 to 40% better than the 4×7 and the QWERTY keyboards.

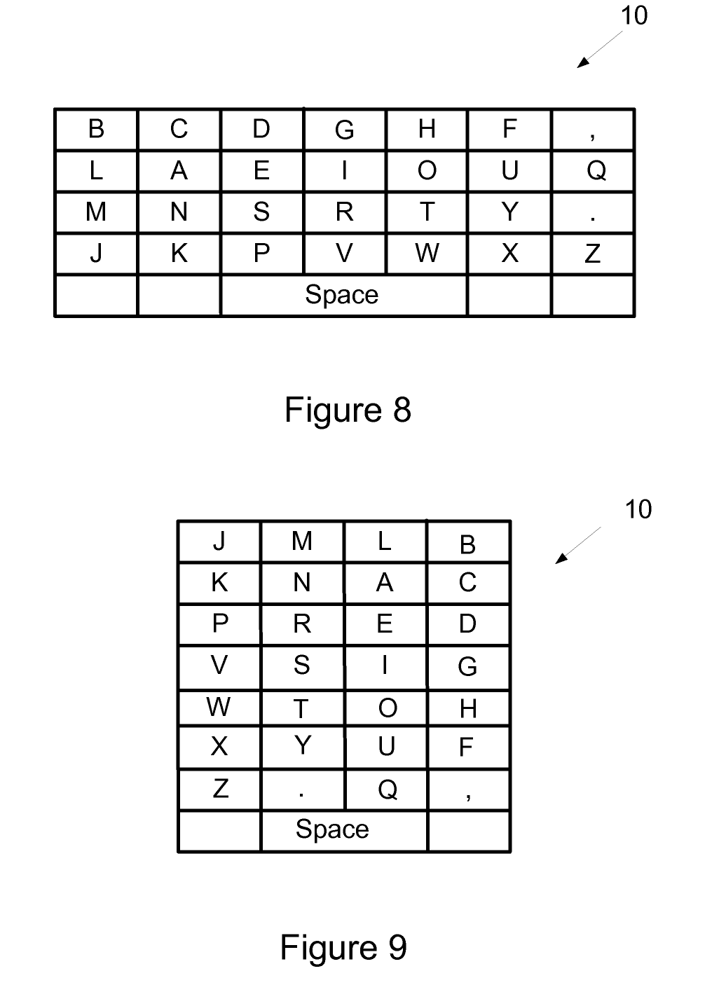

The array of keys 30 shown in FIG. 12 shows a final exemplary layout for the characters of the English alphabet for a keyboard having a 4×8 array of keys. The 5 vowels 32 of the English language are highlighted.

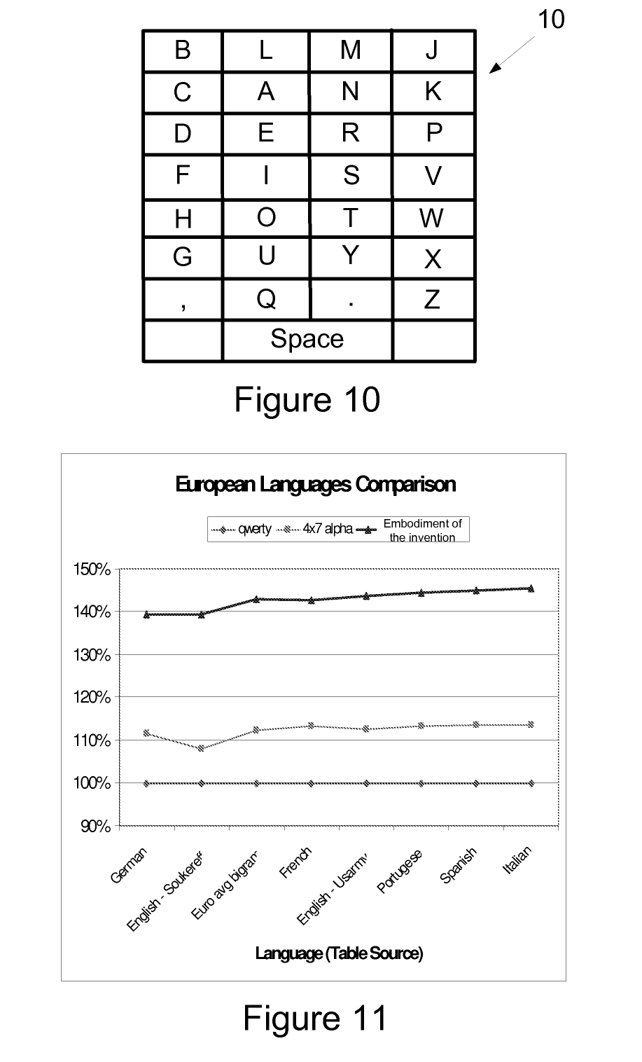

FIGS. 13 to 19 show exemplary arrangements of characters for the array of keys 30 for different vowel-based target languages, other than English. The arrangement of characters for each target language is effected by following the above described layout method steps. In these examples, the vowels 32 have been highlighted and the use of special accents or superscripts has been left out for clarity. There are a number of known mechanisms that can be used to implement such features in software or hardware embodiments.

The array of keys 30 shown in FIG. 13 is a layout for the characters of the Gaelic alphabet that has 18 letters. The Gaelic alphabet does not include the following letters: J, K, Q, V, W, X, Y, Z.

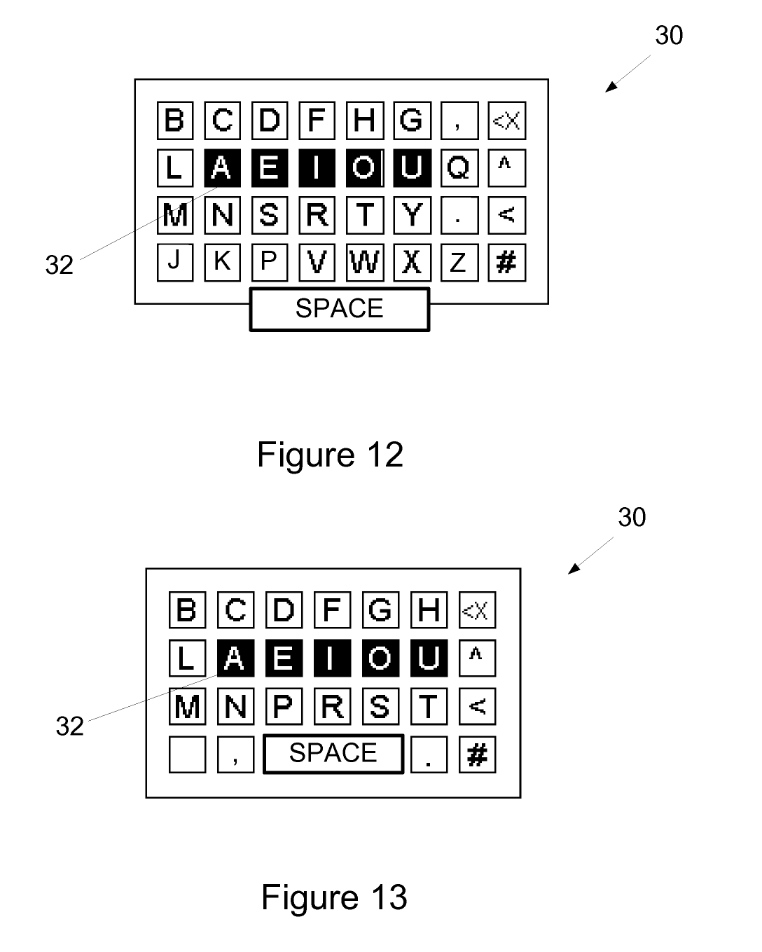

The array of keys 30 shown in FIG. 14 is a layout for the characters of the official South Korean transliteration system, i.e. Korean in the Latin alphabet having 22 letters. The alphabet does not use the following letters: F, Q, V, X.

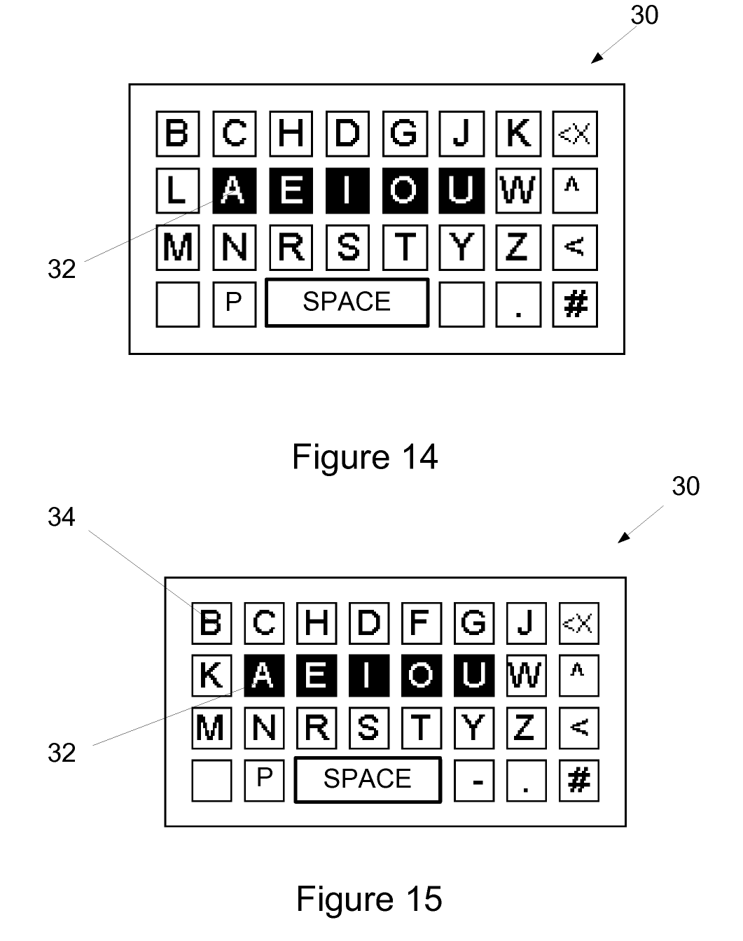

The array of keys 30 shown in FIG. 15 is a layout for the characters of Japanese Romaji with 22 letters in their alphabet. The alphabet does not use the following letters: L, Q, V, X. Nearly all the consonants 34 surround the core vowels 32.

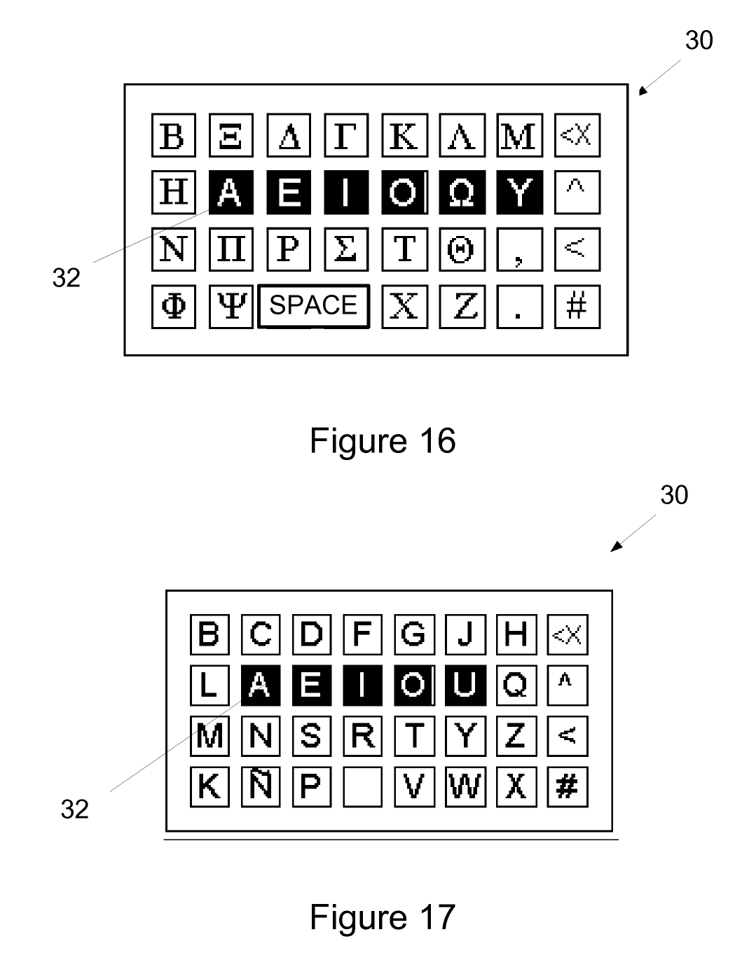

The array of keys 30 shown in FIG. 16 is a layout for the characters of the Greek alphabet that has 24 letters and a special script.

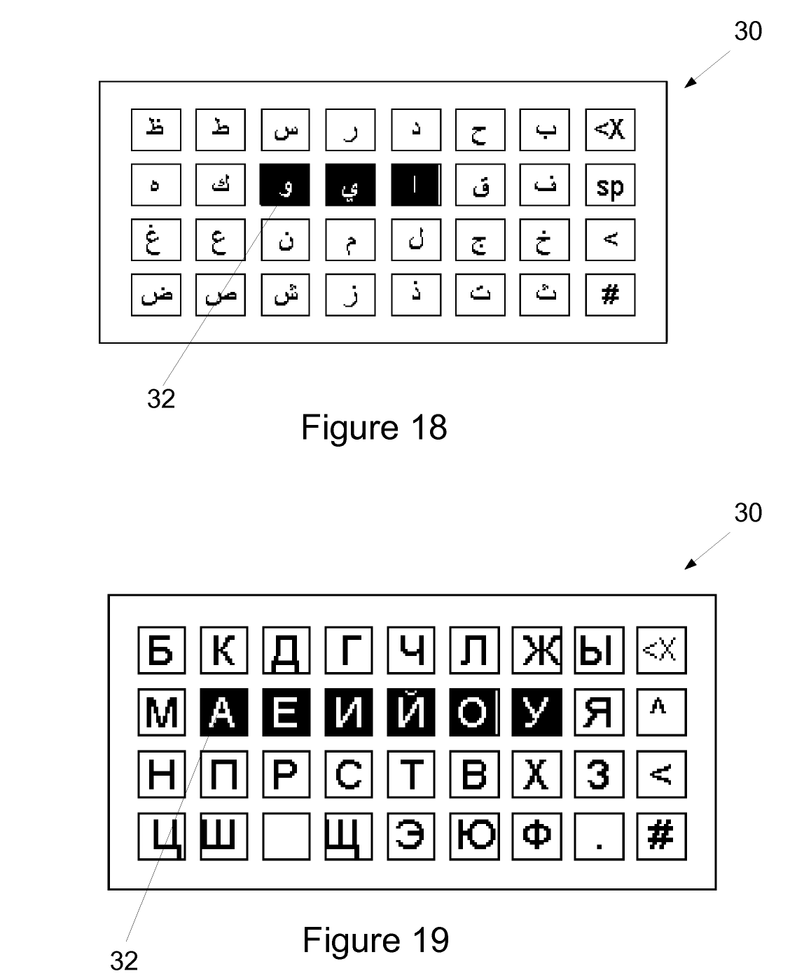

The array of keys 30 shown in FIG. 17 is a layout for the characters for the Spanish language which has an alphabet that is similar to the English alphabet but has different letter frequencies. For example, the “H” character is much more frequent in English than Spanish, while the “J” character is more common in Spanish than in English. The Spanish character for the “ni” sound is considered a separate letter rather than merely an accented character. Since it rarely is the first letter of a word, it has been arranged in the bottom row of the keyboard 30, below the more common letter “N” so that it is easy to find visually.

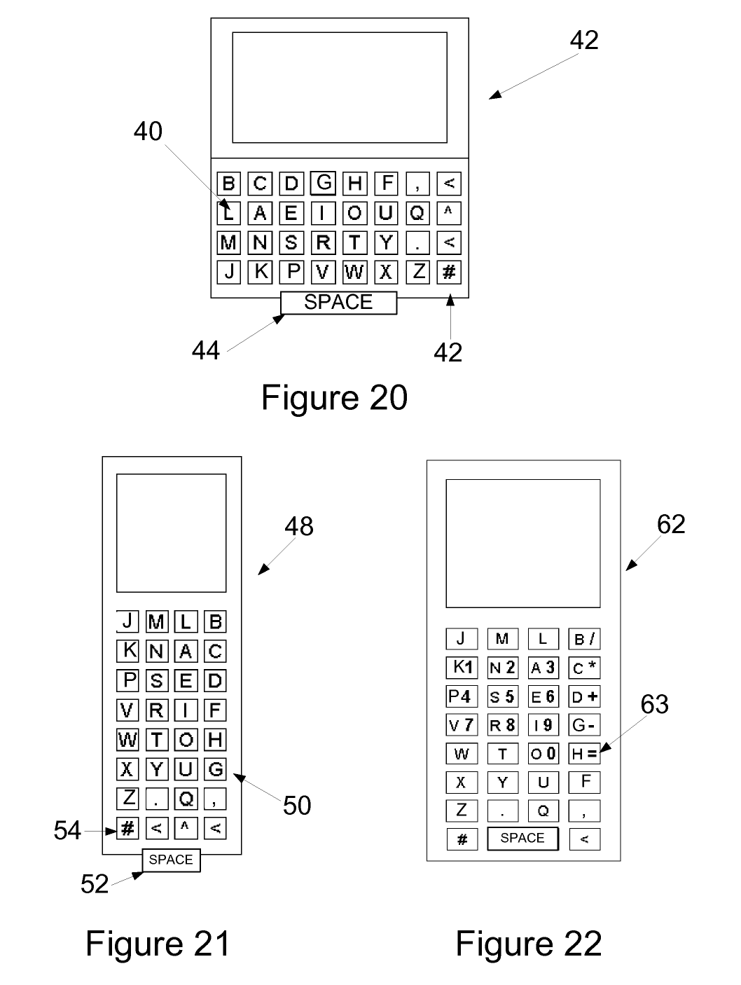

The array of keys 30 shown in FIG. 18 is a layout for the characters of the Arabic alphabet that consists of 28 letters. Arabic is read from right to left. The three main and commonly used long vowels letters ‘alif, yaa and waaw are included on the control keys 32 from right to left respectively.

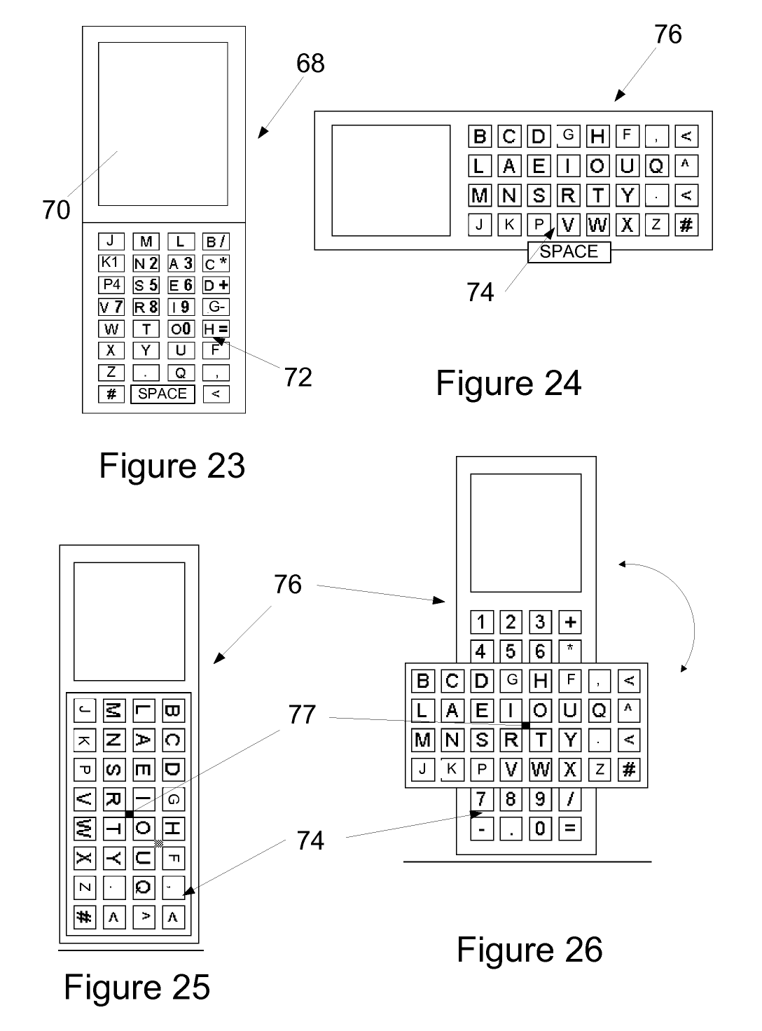

The array of keys 30 shown in FIG. 19 is a layout for the characters for the Russian Cyrillic alphabet which has 29 letters excluding some special characters. The control keys 32 include the commonly used Russian vowels corresponding to A, E, I, J, O and U. There are a few more vowels but these are characters with accents and are rarely used.

The keyboards described previously can be implemented in a hardware form, by making the keys as fixed input buttons of a device. The keyboard may be incorporated as part of the handheld computer device or built as a separate hardware peripheral.

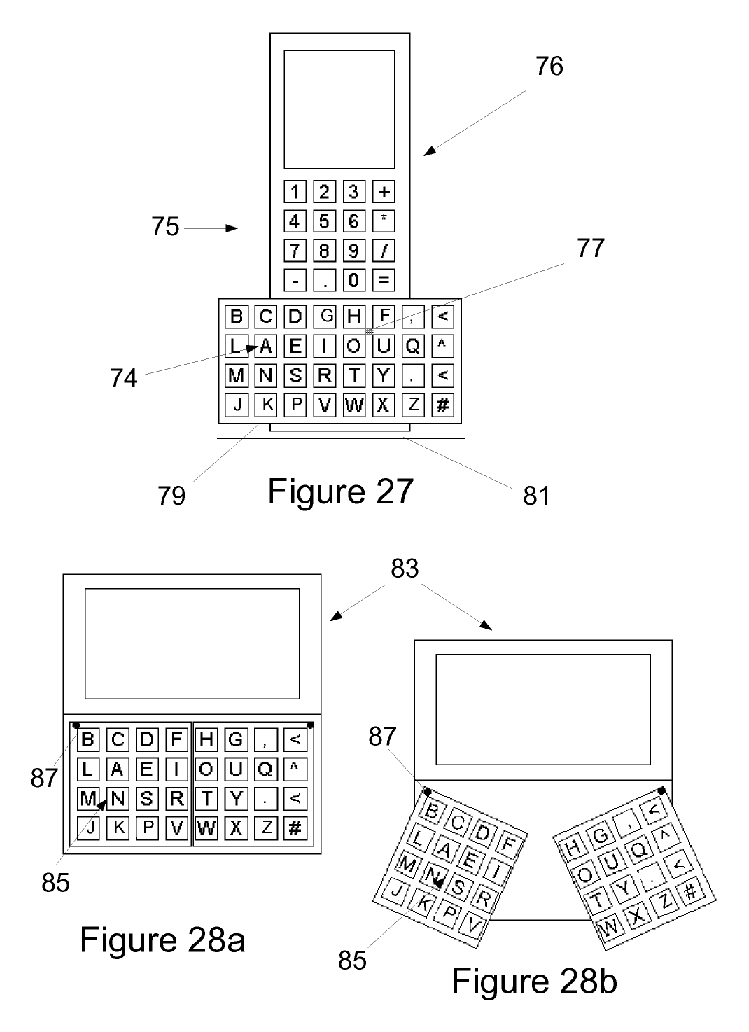

For example, the keyboard 40 of the handheld messaging device 42 shown in FIG. 20 includes character keys arranged for the target language of English. The keyboard 40 has a generally rectangular shape and the travel time to the characters of the keyboard 40 from the centre of the keyboard is minimised. The handheld messaging device 42 includes a horizontal 4 by 7 keyboard 40 with a central “Space” Button 44 on the bottom row and an extra column 46 with ancillary control characters. The keyboard 50 allows the use of buttons that are almost 40% larger than the buttons that would be used on a QWERTY keyboard in the same space on the device 42.

The mobile telephone handset 48 shown in FIG. 21 includes a vertical keyboard 50 having character keys arranged for the target language of English. The keyboard includes a vertical 7 by 4 layout of the characters. The “Space” Button 52 is arranged centrally on the keyboard 50. An extra row 54 with ancillary control characters is placed at the bottom of the keyboard 50.

The device 62 shown in FIG. 22 is similar to the handset 48 shown in FIG. 21, with additional numeric and arithmetical functional keys arranged in a multi-tap configuration with the existing keys. The device 62 is arranged as a vertical keyboard 63 that can be configured for three different purposes: alphanumeric text entry, numeric dialing for a telephone call and use of the device as a simple calculator. To reduce user confusion, the letter “O” is placed on the same key as the number zero “0”.

The clamshell device 68 shown in FIG. 23 includes a screen 70 that can be folded onto the keyboard 72 for protection. The keyboard 72 includes character keys arranged in accordance for the target language of English.

It would be understood by those skilled in the art that variations of the above-described keyboard arrangements are possible. For example, the keyboard of the mobile telephone handset shown in FIG. 21 can be rotated by 90 degrees to form a horizontal keyboard 74 of the mobile telephone device 76 shown in FIG. 24. The keyboard 74 can alternatively pivot with respect to the device 76 about a central point 77 in the manner shown in FIGS. 25 and 26. The keyboard 74 of the device 76 shown in FIG. 27 includes pivots about a point 77 so that the bottom edge 79 of the keyboard 74 is adjacent the bottom edge 81 of the device 76. A swivel or rotating bearing mechanism with a limited range of movement, similar to that used on most flip or clamshell mobile phones, is provided in the device 76 to allow the keyboards to pivot and reveal the additional numeric keys 75 underneath.

The handheld computer device 83, shown in FIG. 28a, includes a split keyboard 85 orientated horizontally. The keyboard 85 includes character keys arranged for the target language of English. Each section of the split keyboard 85 is able to rotate about a pivotal point 87 with respect to the device 83 using a swivel or bearing mechanism. With the left and right sections of the keyboard 85 closed together, the keyboard 85 can be used for one-handed, one-finger or stylus. Alternatively, the left and right sides of the keyboard 85 can be pivoted into the open position shown in FIG. 28b to enable ergonomically effective two handed operation when the mobile device 83 can be placed on a firm surface for typing. The left and right sides of the keyboard are set at an angle of 30 degrees to one another, for example.

The device 89 shown in FIGS. 28c and 28d is similar to the device 83 shown in FIGS. 28a and 28b. However the device 89 includes a split pivoting keyboard 91 with a 4 by 6 array of character keys. The very low frequency keys are doubled together. This enables much larger buttons to be used and the central split to shift to between the “E” and “I” keys rather than the “I” and “O” keys creating a better balance between left and right hand workloads.

The handheld computer device 78 shown in FIG. 29 includes a screen 80 that separates first and second keyboards 82,84. The keyboards 82,84 are arranged horizontally in a split layout for efficient messaging with left and right thumbs in the English Language.

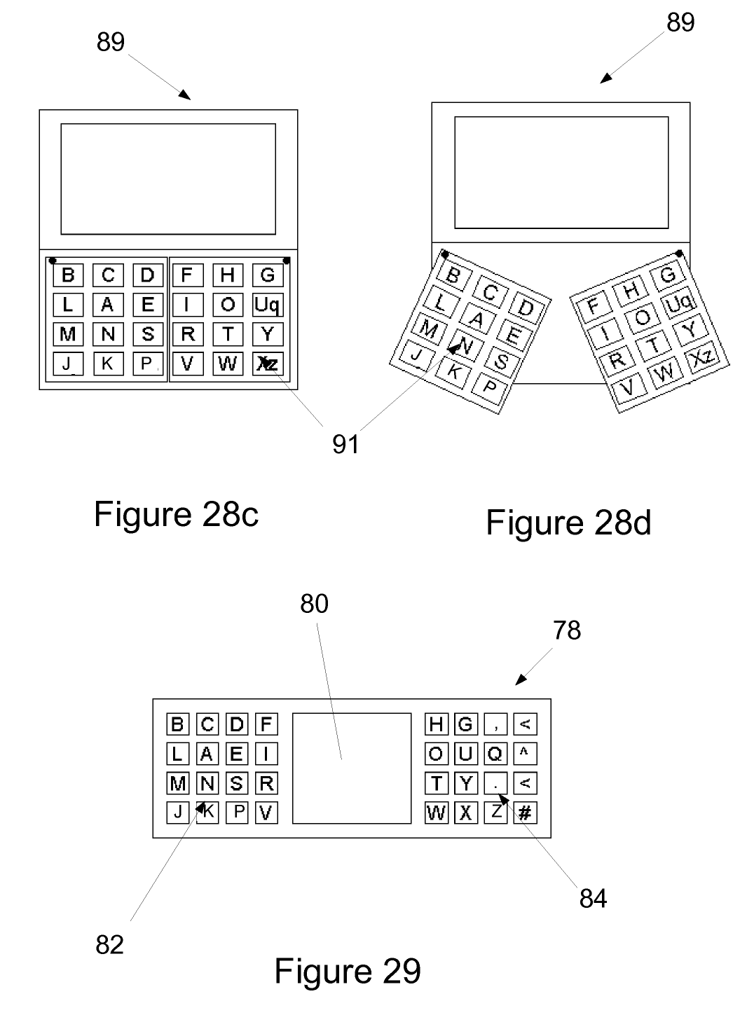

Dual purpose messaging and game devices 86,88 shown in FIGS. 30 and 31 respectively, each include a keyboard 90,92 arranged horizontally that is split with a central screen 94,96. The keyboards 90,92 include character keys arranged in accordance with the above-described method steps for the target language of English. The devices 86,88 are designed for effective gaming and messaging in the English Language. The respective keyboards 90,92 of the devices 86,88 include modified keys that are used for computer games to move an avatar around the screen 90,96 or to initiate specific game actions such as shooting a weapon. The large buttons in FIG. 31 represent joysticks.

Providing easy text entry allows wireless multi-player gamers to “chat” while playing, plot team strategies and tactics or just socialise. While SMS messaging is used with existing 2G mobile phones, the high data rates of 3G phones will allow “instant messaging” dialogues to be cost effective.

The dual purpose messaging and game device 98 shown in FIG. 32 includes a keyboard 100 arranged horizontally. The keyboard 100 includes character keys arranged for the target language of English.

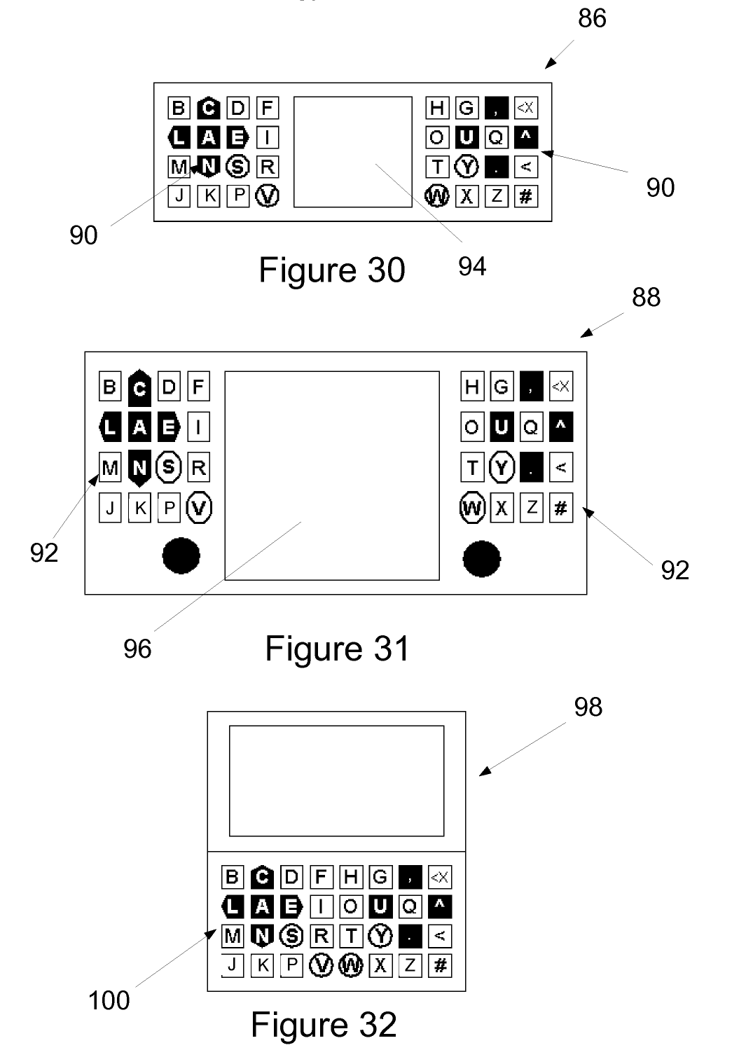

A rectangular keyboard 140, as shown in FIG. 33, is a peripheral hardware device that includes character keys arranged for the target language of English, and is shaped for use with a left hand only. The arrangement of characters can be retrofitted to an existing QWERTY keyboard with suitable driver software. This would be done by rearranging the keycaps of an existing QWERTY keyboard to give the required key layout. The keyboard still sends QWERTY keycodes to the computer, but the driver software translates the keycodes into the desired keyboard output according to the new key layout. A similar keyboard 142 of FIG. 34 is for use with a right hand only.

The keyboard 144 of FIG. 35 is a peripheral device configured primarily for two-handed use rather than one-handed use. Recognising that most users will already be familiar with the QWERTY keyboard, the vowels 146 (AEIOU) and commonly used consonants 148 (TSHR) are placed on the middle row as close as possible to the finger that will be used to type the letter on a QWERTY keyboard. Thus, “A” and “E” are placed on the left hand side of the keyboard and “IOU” are placed on the right hand side of the keyboard. The medium frequency consonants 150 are placed in pseudo-alphabetical order in the row above the vowels where they are easier to see and to reach for “hunt and peck” typists. The remaining low frequency consonants 152 from the end of the alphabet are placed on the bottom row using their familiar original positions on the QWERTY keyboard as a guide. This results in the reverse alphabetical sequence for Z,X,W,V. The main exception is the very common letter “T” that is placed under the right index finger in the home position next to the letter “H”.

The arrangement of the character keys of a two-handed keyboard 144 is based on splitting the most common links between consonants and vowels so that as the right hand types a vowel the other hand is getting into position to strike the next consonant. That is in a two handed keyboard speed comes from having common letter pairs split between left and right sides while in a mono key board the aim is to get common letter pairs together so that a minimum of time is wasted travelling between keys. The most common letters (top 19%, middle 67%, bottom 14%) will be on the middle row in the home position, while the other less frequent letters should be easy to find or recall because they are logically grouped close together around the keyboard.

Additional hardware embodiments are possible, such as wearable keyboards, datagloves, watches with inbuilt PDA functions, handheld data entry devices for industrial applications such as meter-reading and labelling and special input devices for the disabled.

The keyboard can also be implemented in software so as to be presented as a user interface, for example, on a touch screen of a personal digital assistant (PDA) or a Tablet PC.

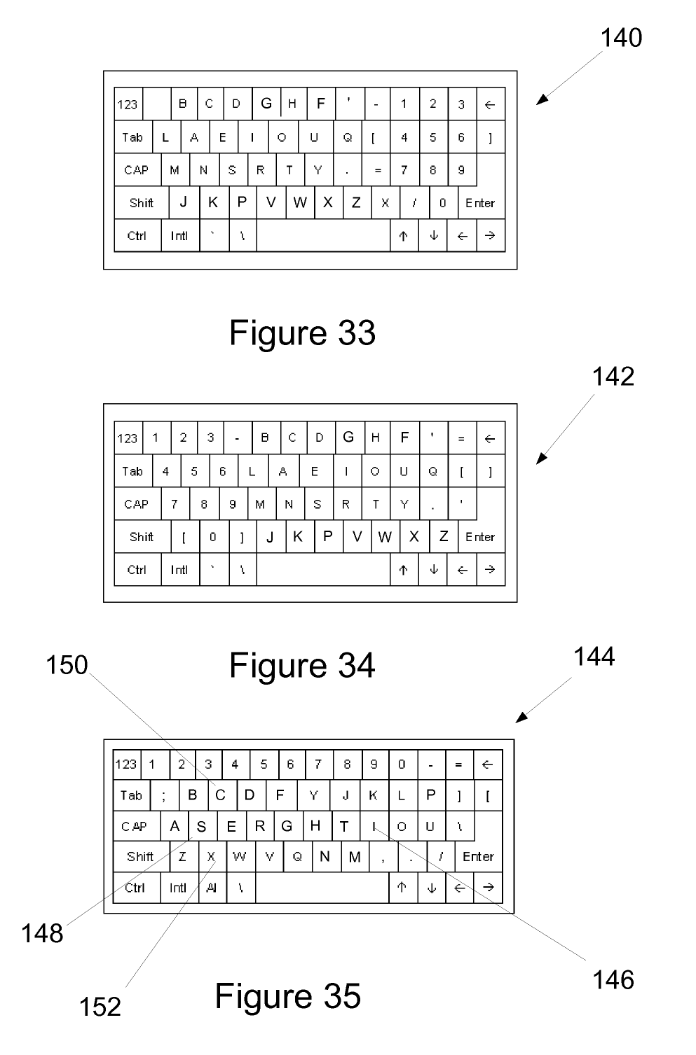

For example, the PDAs 102,104 shown in FIGS. 36 and 37 include interface keyboards 106,108 that include character keys arranged in accordance with the above-described method steps for the target language of English, without and with numeric keyboards.

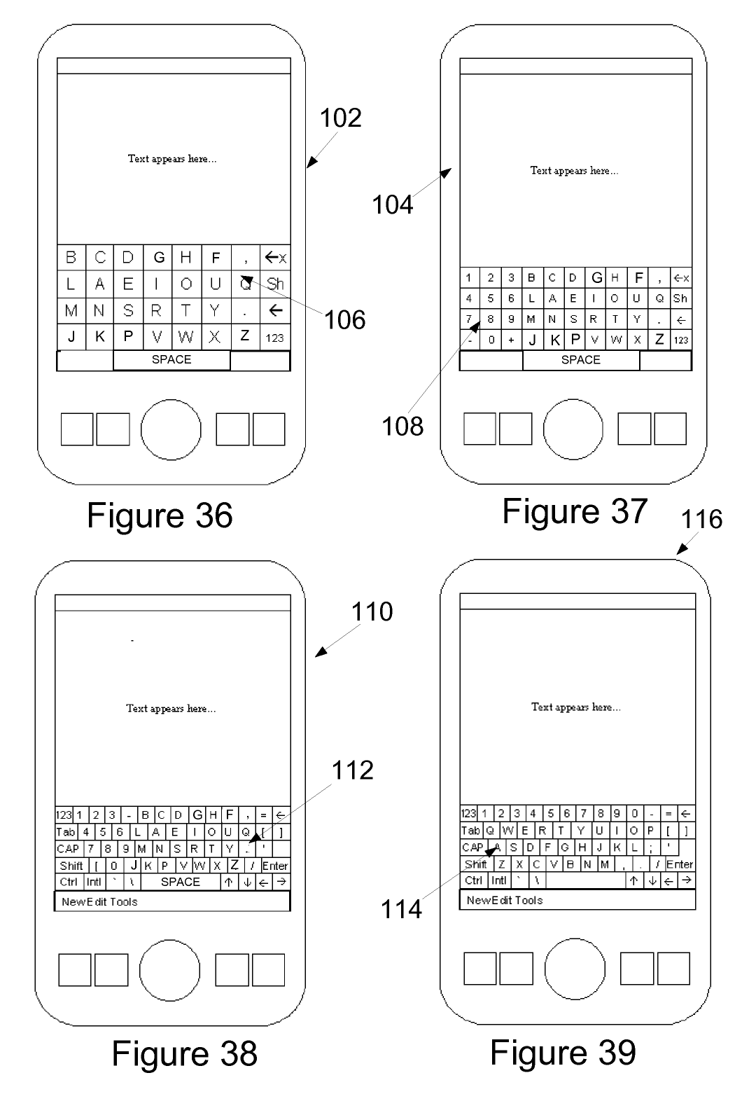

The PDA 110 shown in FIG. 38 includes a keyboard 112 that has character keys arranged for the target language of English. The characters of the keyboard 112 have been placed into a traditional QWERTY keyboard angled grid with a space bar beneath the grid. The 4 by approximately 7 column wide grouping of the vowels and consonants results in less travel from side to side of the full device screen when compared with the 3 by approximately 10 column wide mix of the vowels and consonants in QWERTY keyboard 114 of the PDA 116 shown in FIG. 39. This comparison shows how the stylus will need to travel much shorter distances to type in text—avoiding the left hand number area and rarely entering the bottom row where the low frequency occurrence letters are. Additional benefits also come from not having to move the whole hand from side to side since just moving the fingers provides sufficient range of movement.

The PDA 118 shown in FIG. 40 includes a keyboard 120 that has character keys arranged on a square grid for the target language of English, and has a screen 122 that displays the keyboard in a horizontal landscape orientation. The keys of the keyboard 120 are large enough to be struck directly by a finger or a thumb on the touch screen 122 rather than a stylus. Further speed can be gained by having a dynamic space button that appears adjacent to the last key tapped by the stylus. Thus rather than travelling a relatively long distance to the space bar at the bottom of the keyboard, only a slight movement of the stylus is required, as shown in FIG. 40.

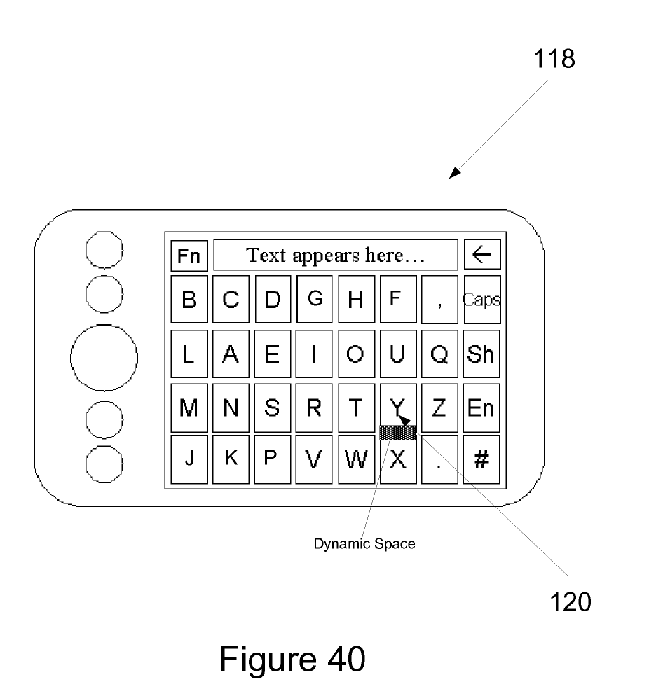

The PDA 132 shown in FIG. 41 has a hybrid hardware/software keyboard implementation and uses a touchpad 134 (rather than touch screen) that is overlaid with a paper, or plastic, image 136 of the keyboard layout to enable data entry.

Joysticks can also be used to navigate a cursor left and right, and up and down for character selection by pressing the associated joystick button. In conjunction with the above-described dynamic space button faster text entry speeds of text entry are possible when compared to multi tap methods.

Additional software embodiments are possible, such as on Tablet PCs where both small keyboards for stylus use as well as large keyboards for two-handed use may be appropriate in different applications. Also virtual keyboard visualisation and eye-tracking technologies such as laser projection onto flat surfaces or even brain-wave driven cursor could use a keyboard according to the present invention.

In the array of character keys 10 of the keyboard shown in FIG. 1, the keys representing frequently used vowel characters 12 of the alphabet are arranged together in series; keys representing frequently used consonant characters 14 of the alphabet are arranged adjacent to the keys representing vowel characters 12; and keys representing infrequently used consonant characters 16 of the alphabet are arranged in positions remote from the keys representing vowel characters. Importantly, the keys representing frequently used consonant characters 14 are arranged in alphabetical order around the keys representing the vowel characters. This arrangement utilises an alphabetical ordering of the most frequent consonant keys 14 around the vowel keys 12 to achieve improved text entry speeds. However, experienced users of QWERTY keyboards, for example, may be reluctant to make the effort to learn a significantly different alphabetical keyboard layout, even if the new arrangement may be more productive in the long run. This problem may be common to all people who have an affinity with a particular type of relational ordering system, such as German QWERTZ, French AZERTY, or DVORAK.

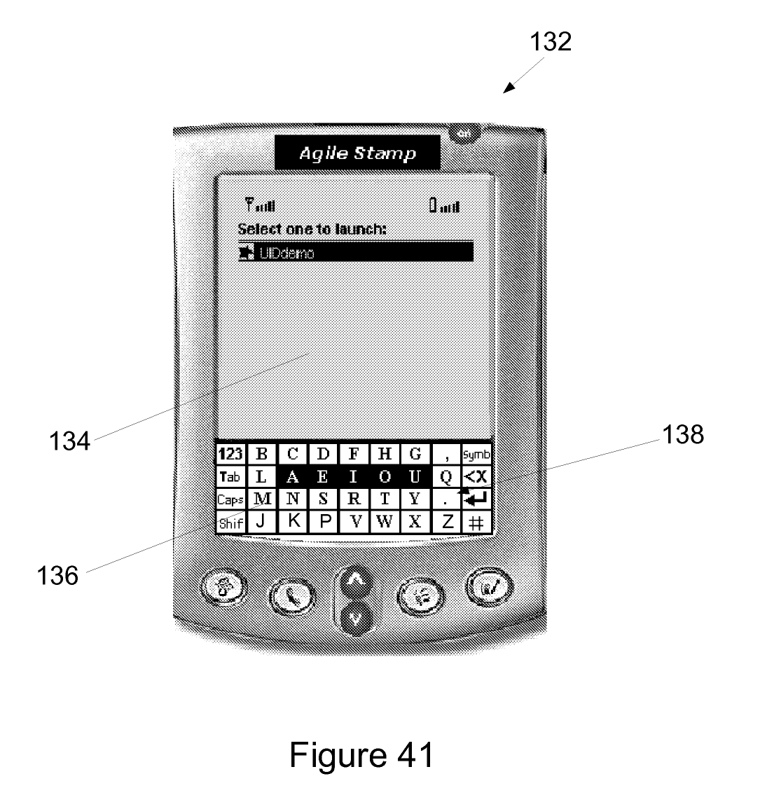

The array of character keys 210 of the key board 200 shown in FIG. 42 represents an alternative arrangement of character keys, wherein the keys representing frequently used consonant characters 214 are arranged in accordance with a relational order around the keys representing the vowel characters 212. In the example shown in FIG. 42, the predetermined relational order is the same as that of a QWERTY keyboard. However, the relational order could, alternatively, be any other suitable relational ordering system such as German QWERTZ, French AZERTY, DVORAK, etc. The arrangement of keys 210 of the keyboard 200 advantageously achieves improved acceptance of the keyboard 200 by current QWERTY keyboard users by being familiar and easy to learn while still delivering improved text entry in handheld devices.

The array of character keys 210 shown in FIG. 42 represents a set of input keys of a one handed keyboard (not shown) for a hand held computer device (not shown). The array includes keys 212 representing frequently used vowel characters of the relevant alphabet arranged together in series; keys 214, 216 representing frequently used consonant characters of the alphabet arranged adjacent to the keys 212 representing vowel characters; and keys 218, 222 representing infrequently used consonant characters of the alphabet arranged in positions remote from the keys 212 representing vowel characters. The keys 214, 216 representing frequently used consonant characters are arranged in a relational order around the keys 212 representing the vowel characters. The relational order is the same as that of a QWERTY keyboard. The handheld computer device may be any device having data processing capabilities and which allows the input of language characters or alphanumeric characters.

The layout of the keys 210 of the keyboard 200 has been determined using a layout method described below for English as a target language. The method can be readily adapted for other target languages. The method begins with a horizontal keyboard which can then be re-oriented in final steps of the method.

(i) Firstly data is obtained on letter use frequencies and commonly used letter pair sequences for the target language.

(ii) Determine shape of the handheld computer device to which the keyboard is coupled; the space available on the handheld computer device for the keyboard; the intended use of the handheld computer device; and the number of vowels and consonants in the target language. Visual processing research has shown that humans can simultaneously “parallel” process about 3 short rows of text imaged onto the eye to quickly identify and recognise about 20 characters. The implication is that a horizontal keyboard should, with respect to an embodiment, be as compact as possible with a target of 3 rows of common characters and as few text-free areas as possible. For example, one-handed keyboards with 4 rows by 7 columns or 5 rows by 6 columns for the 26 letters and SPACE button in the English Language fits this criteria. This compact form factor also has the advantage of allowing larger buttons to be used which also increases usability. Such a layout allows the 5 vowels to be centred in the second row from the top.

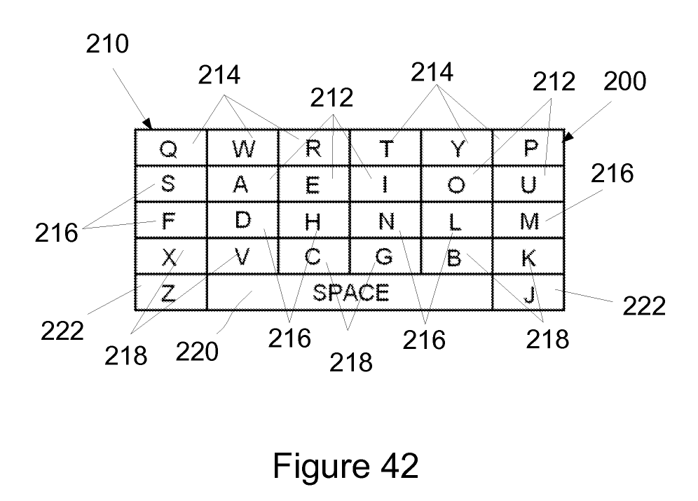

(iii) Identify the vowels in the target language in general usage and arrange them in alphabetical order on a selected generally central row of the array of keys in the manner shown in FIG. 43. For English, all vowels are generally or commonly used, but other languages have accented vowels that are rarely used and should not be placed in the generally central location. For the English language, 72% of words begin with a consonant and there is a 75% probability that the second letter will be a vowel. Thus, the most common consonants that start words must be easy to find and should ideally be adjacent to a vowel that is most likely to the second letter of the word. The five vowels start 28% of words (A 12%, E 2%, I 7%, O 7%, U 1%) and there is a 96% probability that the second letter is a consonant so the vowels must also be easy to find and adjacent to common consonants. Table 7 shows the vowels in the alphabet of the target language being English.

TABLE 7
Letter

A
E
I
O
U

(iv) Select a preliminary position for the “Space” key 220 preferably near the centre of the bottom of the grid, as shown in FIG. 43. This position was found to be preferable in eye-gazing tracking tests of novice users.

(v) Rank remaining consonants of the target language in “qwerty-like” or other preferred key order. Table 8 shows the QWERTY sequence of consonants and the original row position.

TABLE 8

| Letter | Original Row Position |
|---|---|
| q | Top row |
| w | Top row |
| r | Top row |
| t | Top row |
| y | Top row |
| p | Top row |
| s | Middle row |
| d | Middle row |
| f | Middle row |
| g | Middle row |
| h | Middle row |
| j | Middle row |
| k | Middle row |
| l | Middle row |
| z | Bottom row |
| x | Bottom row |
| c | Bottom row |
| v | Bottom row |
| b | Bottom row |
| n | Bottom row |
| m | Bottom row |

(vi) Rank consonants of the target language in descending order of frequency of occurrence. Table 9 shows the relative frequency of use of consonants in the alphabet of the target language.

TABLE 9

| Letter | Frequency | Original Row Position |
|---|---|---|
| t | 1 | Top row |
| n | 2 | Bottom row |
| r | 3 | Top row |
| s | 4 | Middle row |
| h | 5 | Middle row |
| d | 6 | Middle row |
| l | 7 | Middle row |
| f | 8 | Middle row |
| c | 9 | Bottom row |
| m | 10 | Bottom row |
| g | 11 | Middle row |
| y | 12 | Top row |
| p | 13 | Top row |
| w | 14 | Top row |
| b | 15 | Bottom row |
| v | 16 | Bottom row |
| k | 17 | Middle row |
| x | 18 | Bottom row |
| j | 19 | Middle row |
| q | 20 | Top row |
| z | 21 | Bottom row |

(vii) Select the same number of Top Row consonants as there are columns to potentially populate the top row of the alternative keyboard 200. While not necessarily the most frequent consonants, these top row consonants help to increase the familiarity of the keyboard to new users. Arrange these Top Row consonants from Table 9 in QWERTY order on the top row 214 of the array of keys 210, in the manner shown in FIG. 44A

(viii) Select from Table 9 the same number of most frequent middle and bottom row consonants as there are empty spaces 216 in the second and third rows in FIG. 44A and list in QWERTY order. Table 10 shows the selected top row and high frequency consonants of the target language in “qwerty-like” order.

TABLE 10

| Letter | Frequency | Position |
|---|---|---|
| s | 4 | =on row of vowels |
| d | 6 | Row below of vowels |
| f | 8 | |
| h | 5 | |
| l | 7 | |
| c | 9 | |
| n | 2 | |

(ix) Arrange the first consonant 216 from Table 10 adjacent to the vowels 212 on the second row and the remainder of the high frequency consonants 216 below the vowels 212 on the third row in the manner shown in FIG. 44B.

(x) Review the location of the consonants in key positions 214, 216 and move any on the periphery into the centre of the keyboard. Thus the letter “D” in the first column is swapped with the letter “F” and the letter “N” is moved to the left of the letters “L” and “C” in the manner shown in FIG. 44C.

(xi) Consider locations for the remaining lower frequency consonants from Table 9 that will potentially occupy the remaining positions 218, 222 at the bottom of the array of keys 210. Determine how closely each of these consonants corresponds to the characters surrounding each of the positions 216 of the array of keys 210. Arrange or swap a consonant in a position if the degree to which the consonant corresponds to the characters of the keys in a similar “qwerty-like” key position is high. Determine how closely each of the remaining consonants corresponds to the characters in key positions 212, 214, 216 in the first three rows. Replace a character in one of the first three rows if it is apparent that the replacement character would more highly correspond to the characters of the keys surrounding that position than the character that is presently insitu. For example, with reference to FIGS. 44c and 45, replacing the consonant “C” on the far right of the third row with the consonant “M” creates the alphabetical sequence “L M”. As such, the consonant “C” is placed on the third position of the fourth row of the array of keys 210 in the manner shown in FIG. 45. If any one of the remaining consonants in key positions 218 cannot be logically arranged in the first three rows, then arrange the consonant in the fourth or last row near letters that occur in close “qwerty-like” sequence. For example, the sequence “C G B” is placed in the centre of the fourth row to help retain familiarity with a QWERTY keyboard and to place the consonants adjacent to their most common digraphs. For example, C-H, N-G and B-L are very common digraphs. Adjust other positions of displaced letters accordingly in the manner shown in FIG. 45.

(xii) Any remaining very low frequency consonants from Table 9 are then placed in the appropriate QWERTY-like position with the group “Z X V” on the left handside and the pair “K J” on the right hand side. The lowest frequency letters “Z” and “J” are placed in key positions 222 on the fifth row if those are the only remaining positions available as in the manner shown in FIG. 46

(xiii) Validate and test the keyboard 210 with the top 10-100+ words in the target language. The test is extended so as to be conducted when data input rate enhancement methods are added and used with the keyboard. These methods are normally implemented in software and provide predictive word and phrase completion, using “flexible spelling” which predicts words that are spelt phonetically, word bank lists, grammar, “learning” dictionaries, suggested endings, and abbreviation expansion. The keyboard is fine-tuned for common letter-pair combinations such as prefixes that start words where appropriate.

(xiv) If a different orientation of the array of keys 210 is required, then simple rotations and reversals can be made during the layout method to achieve a suitable result.

(xv) Arrange control, number and function buttons on the array of keys 210 to suit the shape of the hand held computer device. Control characters can be placed to suit the purpose and physical construction and ergonomic constraints of a specific handheld computer device. For example, a telephone or calculator device may have numeric indicia placed on dual-purpose keys to enable easy dialing. For some dual thumb or two-handed embodiments described later, splitting the keyboard into a left and right half is also performed here while trying to achieve a balanced workload between left and right hands.

(xvi) Test the arranged characters 210 with novice users for “intuitive” ease of learning and speed of typing compared to their past performance or competing designs. Tests are completed with and without the computer device having rate enhancement methods enabled, and the layout can be adjusted based on user feedback.

Using Soukereff and Mackenzie's industry recognised modelling technique, the theoretical performance of the qwerty-like keyboards having the array of keys 210 shown in FIG. 42 is significantly better than the 4×7 and the QWERTY keyboards.

The array of keys 210 shown in FIGS. 42 and 46 shows a final exemplary layout for the characters of the English alphabet for a keyboard having a 5 rows×6 column array of keys 210. The above described steps for the array 210 of keys of the keyboard 200 can be performed for an alternative relational ordering system, such as German QWERTZ, French AZERTY, or DVORAK.

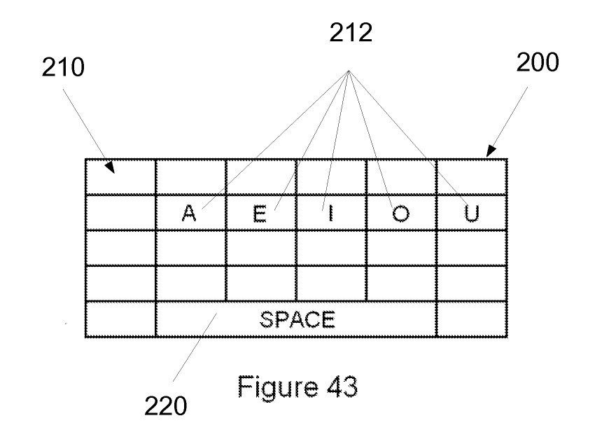

The above described keyboard 200 can be implemented in a hardware form, by making the keys as fixed input buttons of the device. The keyboard 200 may be incorporated as part of the handheld computer device or built as a separate hardware peripheral. For example, the keyboard 200 of the handheld messaging device shown in FIG. 47 includes character keys arranged for the target language of English. The keys of the keyboard 200 utilise the preferred relational order of the most frequent consonants characters 214 around the vowels 212 is “QWERTY” instead of the alphabetical.

The keyboard 200 shown in FIG. 47 has a generally rectangular shape and the travel time to the characters of the keyboard 200 from the centre of the keyboard is minimised. The handheld messaging device 202 includes a horizontal 5 row by 6 column keyboard 200 with a central “Space” Button 220 on the bottom row. The keyboard 200 allows the use of buttons that are almost 40% larger than the buttons that would be used on a QWERTY keyboard in the same space on the same device 202.

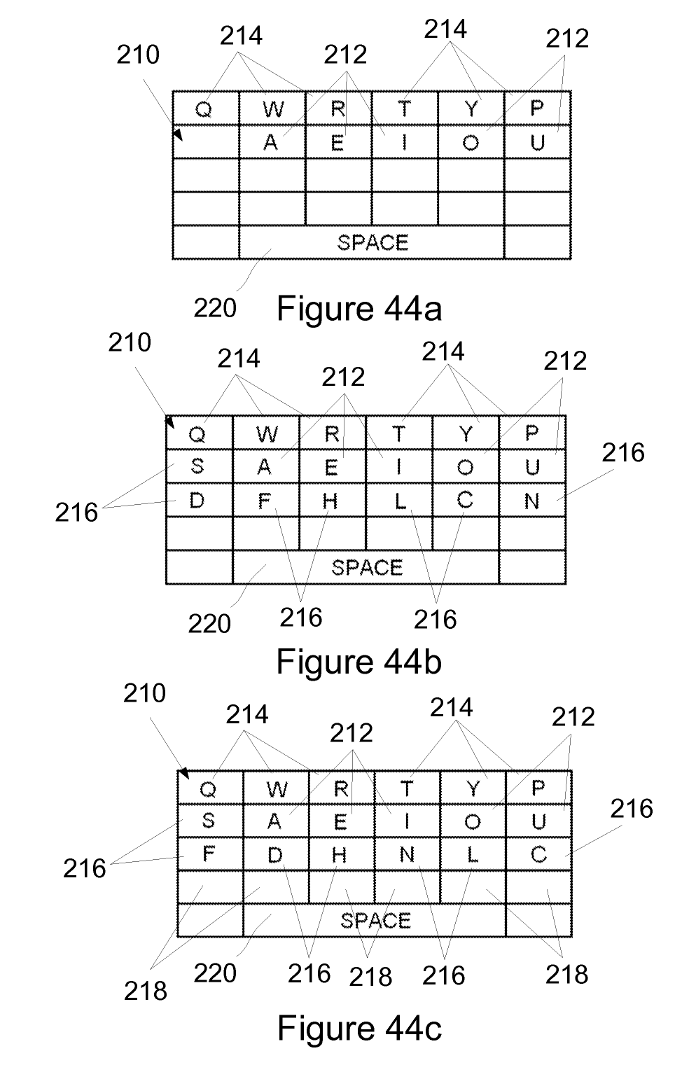

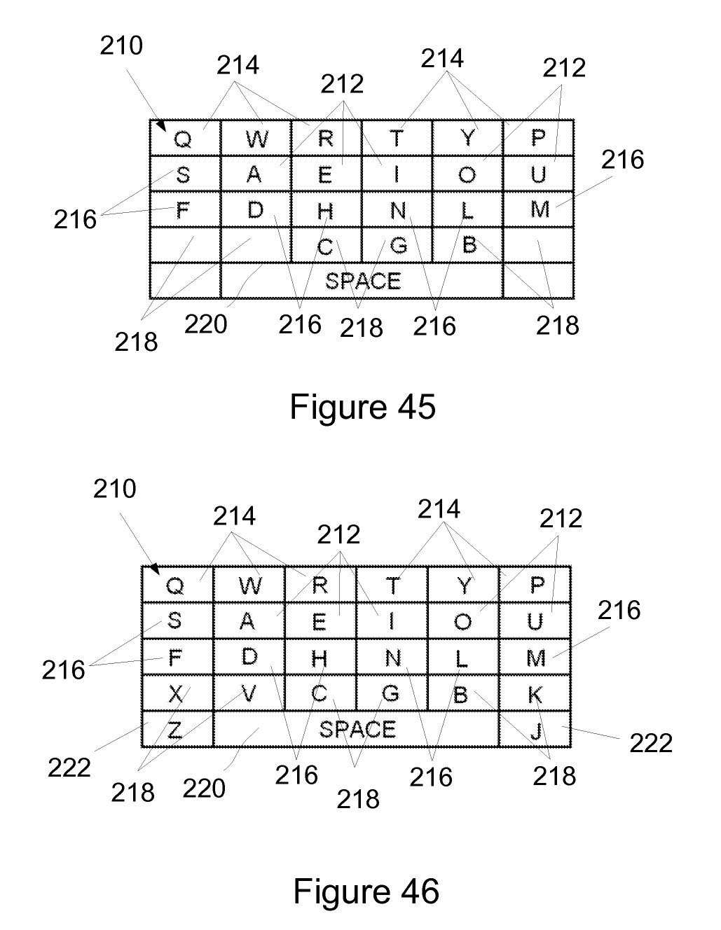

The keyboard 200 may be implemented as a stand alone handheld device 260 that communicates keyboard commands via a cable, radio or infrared or other wireless means to any device with a suitable receiver such as personal digital assistant (PDA), computer or television or any other device requiring remote entry as shown in FIG. 48 with additional ancillary keys 262. A combined keyboard 200 and number pad 264 configuration may be retrofitted to a normal QWERTY keyboard 260 as shown in FIG. 49.

It would be understood by those skilled in the relevant art that variations of the above-described keyboard 200 arrangements in various hardware devices are possible. The keyboard 200 can also be implemented in software so as to be presented as a user interface, for example, on a touch screen of a personal digital assistant (PDA) or a Tablet PC, for example.

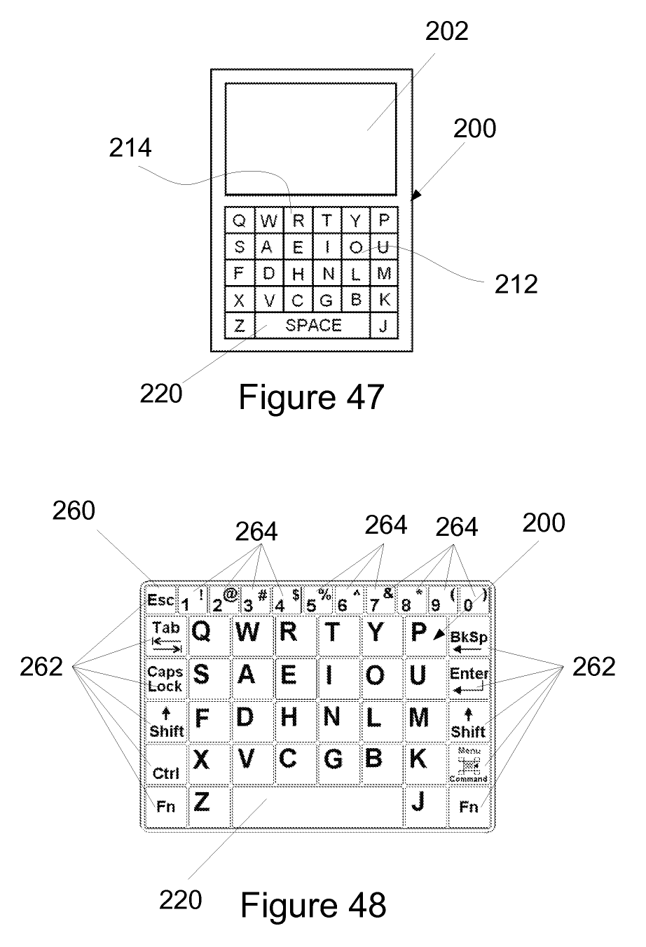

For example, the PDAs 280, 282 shown in FIGS. 50 and 51 include interface keyboards 284, 886 that include character keys arranged in accordance with the above-described method steps for the keyboard 200 for target language of English, without and with numeric keyboards where the large keys are suitable for touching with a finger tip while the small keys are suitable for tapping with a stylus.

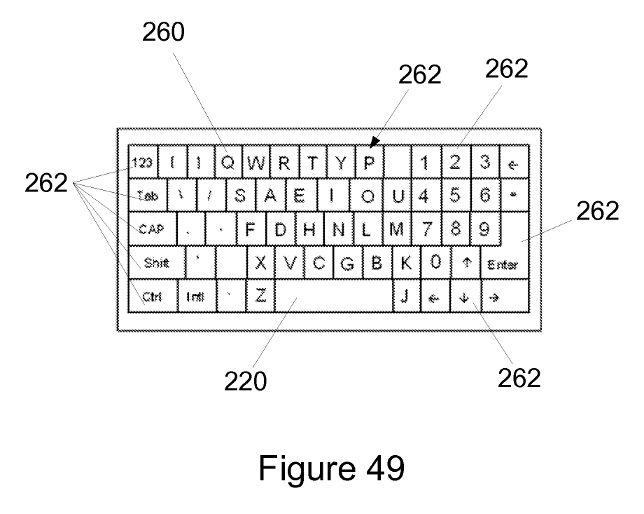

The PDA 290 shown in FIG. 52 includes a keyboard 292 that has an array 294 of character keys arranged for the target language of English. The characters of the keyboard 292 have been placed into a traditional QWERTY keyboard angled grid with a space bar 296 beneath the grid. The 4 by approximately 7 column wide grouping of the vowels and consonants results in less travel from side to side of the full device screen when compared with the 3 by approximately 10 column wide mix of the vowels and consonants in QWERTY keyboard 300 of the PDA 302 shown in FIG. 53. This comparison shows how the stylus will need to travel much shorter distances to type in text—avoiding the left hand number area and rarely entering the bottom row where the low frequency occurrence letters are. Additional benefits also come from not having to move the whole hand from side to side since just moving the fingers provides sufficient range of movement.

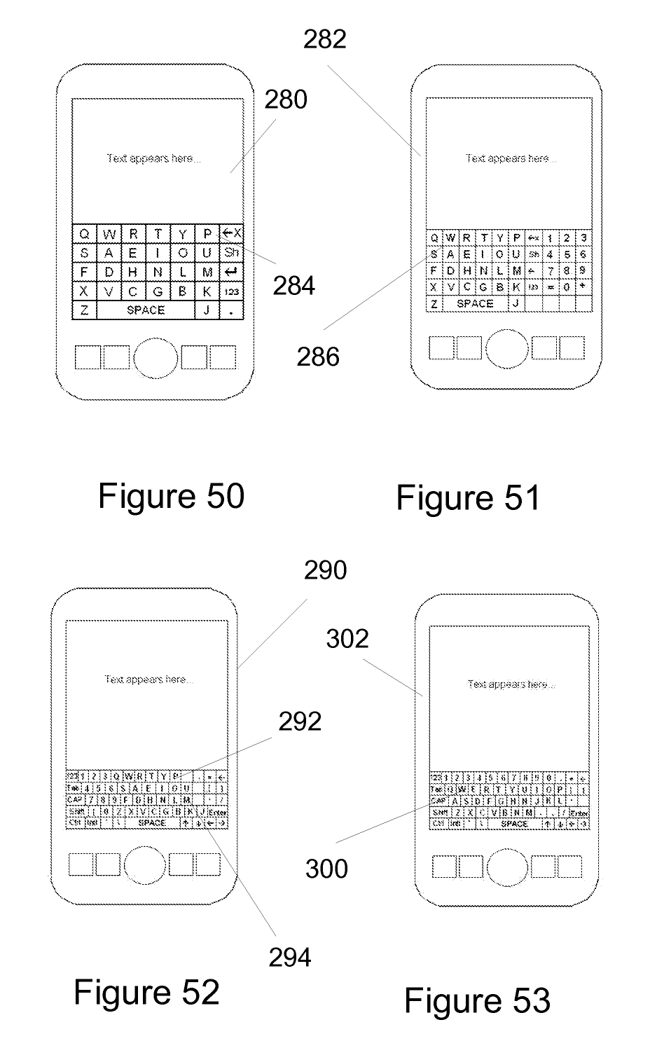

The PDA 310 shown in FIG. 54 includes a keyboard 312 that has an array 314 of character keys arranged in accordance with the array 210 on a square grid for the target language of English. The touch screen 316 displays the keyboard 312 in a horizontal landscape orientation. The keys of the keyboard 312 are large enough to be struck directly by a finger or a thumb on the touch screen 316 rather than a stylus.

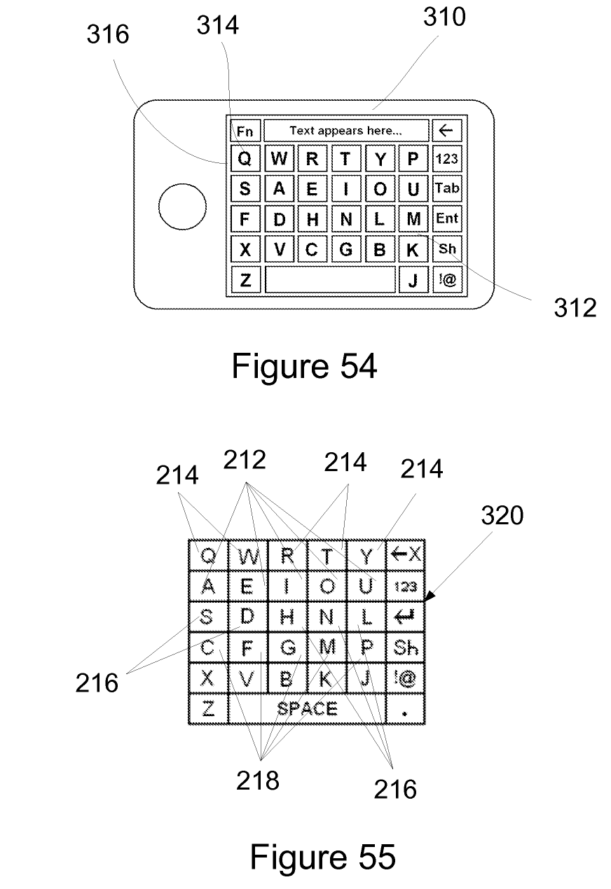

The keyboard 320 shown in FIG. 55 includes a modified version of the keyboard 200 for just 5 columns by 6 rows which may be preferable for some applications requiring a narrower form factor. The key positions 214, 216 for the most frequent consonant letters surround the key positions 212 for the vowel letters in the top three rows, while the key positions 218 for the less frequent consonant letters are in rows 4 and 5 and arranged in a QWERTY-like manner.

Joysticks can also be used to navigate a cursor left and right, and up and down for character selection by pressing the associated joystick button. In conjunction with the above-described dynamic space button faster text entry speeds of text entry are possible when compared to multi tap methods.

Additional software embodiments are possible, such as on Tablet PCs where both small keyboards 200 for stylus use as well as large keyboards for two-handed use may be appropriate in different applications. Also virtual keyboard 200 visualisation and eye-tracking technologies such as laser projection onto flat surfaces or even a brain-wave driven cursor could use a keyboard according to the present invention.

Many modifications will be apparent to those skilled in the art without departing from the scope of the present invention as hereinbefore described with reference to the accompanying drawings.

The reference to any prior art in this specification is not, and should not be taken as, an acknowledgment or any form of suggestion that the prior art forms part of the common general knowledge in Australia.

What is claimed is:

1. A one-handed keyboard for a hand held computer device comprising an array of keys representing characters of an alphabet of a language, wherein the array includes:
keys representing frequently used vowel characters of the alphabet arranged together in series;
keys representing frequently used consonant characters of the alphabet arranged adjacent to the keys representing vowel characters; and
keys representing infrequently used consonant characters of the alphabet arranged in positions remote from the keys representing vowel characters, wherein the keys representing frequently used consonant characters are arranged in a relational order around the keys representing the vowel characters.

2. The keyboard claimed in claim 1, wherein the keys representing frequently used consonant characters are arranged in a non-alphabetical relational order around the keys representing the vowel characters.

3. The keyboard claimed in claim 1, wherein the relational order is the same as that of a QWERTY keyboard.

4. The keyboard claimed in claim 1, wherein the relational order is the same as that of a DVORAK keyboard.

5. The keyboard claimed in claim 1, wherein the relational order is the same as that of a German QWERTZ keyboard.

6. The keyboard claimed in claim 1, wherein the relational order is the same as that of a French AZERTY keyboard.

7. The keyboard claimed in claim 1, wherein one or more keys representing frequently used consonant characters are arranged adjacent to keys representing vowel characters that they are frequently paired together within words of the language.

8. The keyboard claimed in claim 1, wherein one or more keys representing frequently used consonant characters are arranged adjacent to keys representing vowel characters that they are frequently paired together with in the former parts of words of the language.

9. The one-handed keyboard claimed in claim 1, wherein one or more keys representing frequently used consonant characters are arranged adjacent to other keys representing frequently used consonant characters that they are frequently paired together with in words of the language.

10. The one-handed keyboard claimed in claim 1, wherein one or more keys representing frequently used consonant characters are arranged adjacent to other keys representing frequently used consonant characters that they are frequently paired together with in the former parts of words of the language.

11. The one-handed keyboard claimed in claim 1, wherein one or more keys representing less frequently used consonant characters are arranged adjacent to keys representing frequently used consonant characters that they are frequently paired together with in words of the language.

12. The one-handed keyboard claimed in claim 1, wherein one or more keys representing less frequently used consonant characters are arranged adjacent to keys representing frequently used consonant characters that they are frequently paired together with in the former parts of words of the language.

13. The one-handed keyboard claimed in claim 1, wherein the keys representing the frequently used consonant characters are located on opposite sides of the keys representing the vowel characters.

14. The one-handed keyboard claimed in claim 1, wherein the array of keys includes seven columns and four rows.

15. The one-handed keyboard claimed in claim 1, wherein the array of keys includes six columns and five rows.

16. The one-handed keyboard claimed in claim 1, wherein the array of keys includes five columns and six rows.

17. The one-handed keyboard claimed in claim 1, wherein the keys representing frequently used consonant characters for early characters in the relational order are located on one side of the keys representing vowel characters, and the keys representing frequently used consonant characters for later characters in the relational order are located on another other side of the keys representing vowel characters.

18. The one-handed keyboard claimed in claim 1, wherein the keyboard is adapted to separate into left and right halves for respective use by left and right hands of an operator of the keyboard.

19. A method of determining a layout of keys of a one handed keyboard of a hand held computer device, the keys representing characters of an alphabet of a language, the method comprising:
determining frequency of use of characters of the alphabet;
arranging keys representing frequently used vowels characters of the alphabet in series on the one-handed keyboard;
arranging keys representing frequently used consonant characters of the alphabet adjacent to first and second sides of the vowel keys; and
arranging keys representing less frequently used consonant characters of the alphabet in positions on the one-handed keyboard remote from the keys representing the vowel characters, wherein the keys representing frequently used consonant keys being arranged in a relational order around the keys representing vowel characters.

20. The method claimed in claim 19, wherein the keys representing frequently used consonant characters are arranged in a non-alphabetical relational order around the keys representing the vowel characters.

21. The method claimed in claim 19, wherein the relational order is the same as that of a QWERTY keyboard.

22. The method claimed in claim 19, wherein the relational order is the same as that of a DVORAK keyboard.

23. The method claimed in claim 19, wherein the relational order is the same as that of a German QWERTZ keyboard.

24. The method claimed in claim 19, wherein the relational order is the same as that of a French AZERTY keyboard.

25. The method claimed in claim 19, wherein one or more keys representing frequently used consonant characters are arranged adjacent to keys representing vowel characters that they are frequently paired together with in words of the language.

26. The method claimed in claim 19, wherein one or more keys representing frequently used consonant characters are arranged adjacent to keys representing vowel characters that they are frequently paired together with in the former parts of words of the language.

27. The method claimed in claim 19, wherein one or more keys representing frequently used consonant characters are arranged adjacent to other keys representing frequently used consonant characters that they are frequently paired together with in words of the language.

28. The method claimed in claim 19, wherein one or more keys representing frequently used consonant characters are arranged adjacent to other keys representing frequently used consonant characters that they are frequently paired together with in the former parts of words of the language.

29. The method claimed in claim 19, wherein one or more keys representing less frequently used consonant characters are arranged adjacent to keys representing frequently used consonant characters that they are frequently paired together with in words of the language.

30. The method claimed in claim 19, wherein one or more keys representing less frequently used consonant characters are arranged adjacent to keys representing frequently used consonant characters that they are frequently paired together with in the former parts of words of the language.

31. The method claimed in claim 19, wherein the number of keys representing the frequently used consonant characters is equal to twice the number of keys representing the vowel characters.

32. The method claimed in claim 19, wherein the array of keys includes seven columns and four rows.

33. The method claimed in claim 19, wherein the array of keys includes six columns and five rows.

34. The method claimed in claim 19, wherein the array of keys includes five columns and six rows.

35. The method claimed in claim 19, wherein the keys representing frequently used consonant characters for early relational order consonants are on one side of the keys representing vowel characters, and the keys representing frequently used consonant characters for later relational order consonants are located on another other side of the keys representing vowel characters.

36. A one-handed keyboard having a layout of keys determined by the method claimed in claim 19.

37. A hand held computer device comprising a one-handed keyboard claimed in claim 1.

38. A one-handed keyboard for a hand held computer device comprising an array of keys representing characters of an alphabet of a language, wherein the array comprises:
keys representing frequently used vowel characters of the alphabet arranged together in series;
keys representing frequently used consonant characters of the alphabet arranged adjacent to the keys representing vowel characters; and
keys representing infrequently used consonant characters of the alphabet arranged in positions remote from the keys representing vowel characters, wherein the keys representing frequently used consonant characters are arranged in a relational order around the keys representing the vowel characters, and keys representing infrequently used consonant characters for left hand relational order consonants are arranged on the left hand side of the one-handed keyboard, and keys representing infrequently used consonant characters for right hand relational order consonants are arranged on the right hand side of the one-handed keyboard.

39. The keyboard claimed in claim 38, wherein the keys representing frequently used consonant characters are arranged in a non-alphabetical relational order around the keys representing the vowel characters.

40. The keyboard claimed in claim 38, wherein the relational order is the same as that of a QWERTY keyboard.

41. The keyboard claimed in claim 38, wherein the relational order is the same as that of a DVORAK keyboard.

42. The keyboard claimed in claim 38, wherein the relational order is the same as that of a German QWERTZ keyboard.

43. The keyboard claimed in claim 38, wherein the relational order is the same as that of a French AZERTY keyboard.

44. The one-handed keyboard claimed in claim 38, wherein the keys representing infrequently used consonant characters for left hand relational order consonants are arranged on the bottom left hand corner of the one-handed keyboard, and the keys representing infrequently used consonant characters for right hand relational order consonants are arranged on the bottom right hand corner of the one-handed keyboard.

45. A method of determining a layout of keys of a one-handed keyboard of a hand held computer device, the keys representing characters of an alphabet of a language, the method comprising:
determining frequency of use of characters the alphabet;
arranging keys representing frequently used vowels characters of the alphabet in series on the one-handed keyboard;
arranging keys representing frequently used consonant characters of the alphabet adjacent to first and second sides of the vowel keys; and
arranging keys representing less frequently used consonant characters of the alphabet in positions on the keyboard remote from the keys representing the vowel characters, wherein the keys representing frequently used consonant keys being arranged in a relational order around the keys representing vowel characters, and keys representing infrequently used consonant characters for left hand relational order consonants are arranged on the left hand side of the one-handed keyboard, and keys representing infrequently used consonant characters for right hand relational order consonants are arranged on the right hand side of the one-handed keyboard.

46. The method claimed in claim 45, wherein the keys representing infrequently used consonant characters for left hand relational order consonants are arranged on the bottom left hand corner of the one-handed keyboard, and the keys representing infrequently used consonant characters for right hand relational order consonants are arranged on the bottom right hand corner of the one-handed keyboard.
